(19) United States
(12) Patent Application Publication
(10) Pub. No.: US 2018/0216988 A1
(43) Pub. Date: Aug. 2, 2018

(54) METHOD AND APPARATUS FOR MONITORING AND AVOIDANCE OF UNANTICIPATED LOADS APPLIED TO AIRCRAFT LANDING GEAR

(71) Applicant: C. Kirk Nance, Keller, TX (US)

(72) Inventor: C. Kirk Nance, Keller, TX (US)

(21) Appl. No.: 15/935,870

(22) Filed: Mar. 26, 2018

Related U.S. Application Data
(63) Continuation-in-part of application No. 14/502,680, filed on Sep. 30, 2014, now Pat. No. 9,927,319.
(60) Provisional application No. 61/885,217, filed on Oct. 1, 2013.

(51) Int. Cl. G01G 19/10; G01G 23/36; B64C 25/00; B64D 45/00

(52) U.S. Cl. CPC G01G 19/10; G01G 23/36; G01G 19/417; B64D 45/00; B64C 25/001

(57) ABSTRACT

A method of determining and identifying acceptable and unacceptable ranges of loads applied to a nose landing gear of an aircraft on the ground during passenger loading and unloading events. A method of determining and identifying acceptable and unacceptable ranges of loads applied to a nose landing gear of an aircraft on the ground during baggage and cargo loading and unloading events. A method of determining and identifying acceptable and unacceptable ranges of loads applied to a main landing gear of an aircraft on the ground during a fuel loading event. A method for aircraft flight crew and ground support personnel to monitor and identify in real-time, unanticipated loads experienced by the aircraft landing gear; to better manage the loading and unloading of passengers, baggage and cargo to and from an aircraft. Pressure sensors are attached to telescopic landing gear, which monitor the working pressure within the aircraft landing gear, and further identify and illuminate an onboard indicator to recognize unanticipated loads experienced by the nose landing gear during the passenger movement within the aircraft cabin while the aircraft is on the ground. Unbalanced fuel loading is recognized by asymmetrical pressures within the main landing gear struts, and identified during the aircraft fueling process.

This application is a continuation-in-part application of U.S. patent application Ser. No. 14/502,680, filed Sep. 20, 2014, which application claims the benefit of application Ser. No. 61/885,217, filed Oct. 1, 2013.

### FIELD OF THE INVENTION

The present invention relates to a method and apparatus for monitoring aircraft loads and in particular to monitoring aircraft loads on landing gear while the aircraft is being loaded and unloaded.

### BACKGROUND OF THE INVENTION

For safe operation of an aircraft, the weight and Center of Gravity of the aircraft must be determined prior to take-off. Airlines (also referred to as: FAA/Part 121 “Air Carriers”) have strict departure schedules, which are maintained to maximize aircraft utilization each day. Today's airline operations typically do not place fully loaded aircraft upon scales as a means to measure the aircraft weight, and the distribution of that weight, commonly referred to as the aircraft Center of Gravity (“CG”), prior to an aircraft's departure (“dispatch”) from an airport gate.

An aircraft is typically supported by plural and in most cases three pressurized landing gear struts. The three landing gears are comprised of two identical Main Landing Gear (“MLG”) struts, which absorb landing loads and a single Nose Landing Gear (“NLG”) strut used to balance and steer the aircraft as the aircraft taxi on the ground. Designs of landing gear incorporate moving components, which absorb the impact force of landing. Moving components of an aircraft landing gear shock absorber are commonly vertical telescopic elements. The telescopic shock absorber of landing gear comprise internal fluids, both hydraulic fluid and compressed nitrogen gas, and function to absorb the vertical descent forces generated when the aircraft lands. While the weight of the aircraft is resting on the ground, the weight of the aircraft is “balanced” upon three pockets on compressed gas within the landing gear struts.

Measuring changes in the three landing gear strut internal pressures will in turn identify the aircraft CG, and identify the distribution and subsequent re-distribution of aircraft loads associated at each respective landing gear.

This invention discloses a method of measuring aircraft CG independent of measuring the aircraft weight. As mentioned above, one way to measure aircraft weight involves rolling the aircraft onto platform weighing scales, which measure the weight supported at each independent landing gear strut. With an aircraft utilizing three landing gear, the measured weight at each of the three respective floor scales are summed together to measure the total weight of the aircraft. The weight of the two main landing gear are summed to determine the weight supported by the combined main landing gear, and the nose landing gear weight is then compared to the combined main landing gear weight. The aircraft CG is determined from the distribution of weight on the nose landing gear relative to the main landing gear. As that distribution of weight changes, so does the location of the aircraft CG.

This invention discloses methods for aircraft flight crew to identify unanticipated loads applied to the aircraft landing gear.

Airline dispatch thousands of flights daily, without measuring the weight of the aircraft. The take-off weight determination made by the airlines use a measured weight of the empty aircraft, and assumptions as to the passenger weights, bag weights, and assumptions of fuel density as a conversation is made from gallons of fuel pumped into the aircraft to be shown in pounds of weight displayed on the aircraft cockpit fuel indicators.

Today's airline flight crew operations are not equipped with any visual indications to the flight crew, allowing for landing gear load monitoring in real-time, to assure ongoing operational loading of the aircraft remains within the acceptable range of loads, applied to the respective aircraft landing gear struts.

The landing gear struts are the 2^{nd} most expensive component on the aircraft. Being 2^{nd} only to that of the cost of the aircraft engines. The landing gear for a Boeing 737-800 cost more than $5,000,000.00 (in US dollars 2016). It may not be not commonly known that the smaller nose landing gear is more expensive than either of the main landing gear. The complexity of the nose landing gear to be steerable, along with the structural enhancements of being attachable to the aircraft tug for towing the aircraft, drive up the costs for the nose landing gear strut. With the nose landing gear being such an expensive component, it would be beneficial to not add excessive loads onto the nose landing gear as passengers board the aircraft. Having a visible indicator available to the cabin crew, located in a convenient position near the passenger loading door, allows the cabin crew to verify the range of loads being applied to the nose landing gear, as the passenger aisle of the aircraft becomes congested during loading, when too many additional passengers step off of the jet-bridge, to crowd into the area located adjacent to the aircraft forward galley. In additional to the weight of passengers with carry-on bags standing directly over the nose landing gear; the flight catering services are also adding weight to this same nose landing gear, as they load bags of ice and multiple cases of beverages and food items to the forward galley area. The galley area is also located directly above the nose landing gear. The flight attendant having an ability to determine that nose landing gear loads are increasing to an excessive range, can allow the flight crew to halt those passengers still on the jet-bridge, who are trying to crowd onto the front galley area on the aircraft, in order to allow passengers who have already boarded the aircraft more time to proceed aft into the aircraft cabin, thus reducing the loads applied to nose landing gear.

Without a visual indicator of the loads being applied to the nose landing gear, the flight attendant has no tool available to help reduce excessive loads from being applied to the nose landing gear.

All air carriers must have FAA approved procedures in place (“an approved schedule”), in which the air carrier will follow such procedures to insure each time an aircraft is loaded, the load will be distributed in a manner that the aircraft CG will remain within the FORWARD (“FWD”) and AFTWARD (“AFT”) CG limitations. The FAA and the specific air carrier develop these procedures, which are often referred to as “loading laws” and when implemented define how the aircraft is loaded. An accurate determination of the total passenger weight portion of a flight could most readily be accomplished by having a scale located at the entrance to the aircraft door, by which all weight that enters the aircraft would be measured. Though this solution sounds simple, having the measured weight of the passengers and their carry-on items could cause substantial disruption in an airline's daily flight schedule. Such disruption would occur moments before the aircraft is scheduled to depart and when it is discovered that the aircraft measured weight and/or CG do not match the aircraft's planned, or computed, weight and balance computations.

The aircraft operator will use approved loading schedules to document compliance with the certificated aircraft weight and CG limitations contained in the aircraft manufacturer's Aircraft Flight Manual (AFM), for the compiling and summing of the weights of various aircraft equipment, fuel and payload weights, along with the AC120-27E weight designations for passengers and baggage. These types of loading schedules are commonly referred to as the Load Build-Up Method (LBUM).

The aircraft LBUM weight and CG determinations are “computed” with the use of guidance from AC120-27E, which define the approved methods to determine the aircraft weight using “weight assumptions” which are independent of any requirement to use scales to measure of the aircraft total weight at dispatch. The fully loaded weight of the aircraft is established through a process of compiling the weights of various payload items based upon FAA approved “designated” average weights, for the varying elements such as passengers, carry-on baggage, checked baggage, crew weight, cargo weight and the weight of fuel loaded, onto a previously measured empty aircraft weight. The location of each of these elements of payload weight are further computed, allowing the airline to determine where the aircraft CG is located.

The following paragraphs include the original BACKGROUND OF THE INVENTION.

There are many critical factors the pilot of an aircraft must consider when determining if the aircraft is safe for take-off. Some of those factors are identifying the proper weight and center of gravity for the aircraft. Hereinafter, aircraft “Center of Gravity” will be referred to as aircraft “CG.”

Aircraft CG is a critical factor in flight operations. If the aircraft CG is too far aft and outside the aircraft's certified CG limits, the aircraft nose can rise uncontrollably during take-off, where the aircraft will become unstable, resulting in a stall and possible crash.

Furthermore, fuel is the most costly item in an airline's annual expenses. Airline profit margins are slim at best, so any and all efforts must be used to reduce fuel consumption. Aircraft CG location affects the amount of fuel the aircraft burns. If an aircraft is loaded with the CG positioned towards the forward limit of the aircraft's CG envelope, the pilot must add rear stabilizer trim for the nose-heavy aircraft. This additional rear stabilizer trim will increase the aerodynamic drag on the aircraft, thus burn more fuel. If an aircraft can be loaded with the aircraft CG positioned near the aft limit of the aircraft CG envelope, the aircraft will require less trim and be more fuel efficient.

In a search of the prior art, there are numerous onboard aircraft weighing systems which measure aircraft weight. The measured aircraft weight is subsequently used to determine aircraft CG. Research of the prior art to identify automatic aircraft weighing systems are well documented and reference may be made to United States patents:

#3,513,300—Elfenbein
#3,584,503—Senour
#3,701,279—Harris
#5,214,586—Nance
#5,521,827—Lindberg
#5,548,517—Nance
#6,128,951—Nance
#6,237,406—Nance
#6,237,407—Nance
#7,967,244—Long

The prior art described by these patents explain mechanical apparatus added to a landing gear strut which measure the weight of the aircraft. Typical aircraft used in day-to-day airline operations are commonly supported by a plurality of compressible, telescopic landing gear struts. These landing gear struts contain pressurized hydraulic fluid and nitrogen gas. The weight of the aircraft rests upon and is supported by “pockets” of compressed nitrogen gas, within the landing gear struts. Aircraft weight supported by these pockets of gas is called the “sprung” weight. There is additional aircraft weight, which is not identified by changes in landing gear strut pressure. This additional weight is associated with various landing gear components located below the pockets of compressed gas including such items as the wheels, tires, brakes, strut piston, and other lower landing gear components. Aircraft weight associated with these lower landing gear components located below the pockets of compressed gas is called the “unsprung” weight. Unsprung weight remains a relatively constant weight. Aircraft brake wear and tire wear result in a minimal and virtually insignificant amount of weight loss to the unsprung weight. The unsprung weight is typically added to the sprung weight, to identify total aircraft weight.

The methods of prior art aircraft weighing systems, determine the “sprung” weight of the aircraft by measuring the pressure within the landing gear struts and multiplying strut pressure by the load supporting surface area of the strut piston. Among the disadvantages of the prior art onboard aircraft weight measuring systems are that airlines can suffer severe schedule disruptions by using a “measured” aircraft weight value, as opposed to methods of “calculating” aircraft weight based upon FAA approved “assumed” weights, of varying weight items such as airline passengers and baggage, loaded onto the aircraft.

Aircraft load planning is a crucial part of keeping an airline running on schedule. A scheduled aircraft departure will commence its load planning process up to one year prior to the actual flight. Airlines do not offer ticket sales for a flight, more than twelve months prior to the flight. As each ticket for a scheduled flight is purchased, the average passenger and average bag weights are assigned into a computer program, continually updating throughout the year the planned load for that flight. Aircraft have a maximum design take-off weight limitation, where airline operations use assumptions as to the weight of passengers and baggage loaded onto the aircraft, to stay below the aircraft take-off weight limitation. The Federal Aviation Administration has published an Advisory Circular “AC 120-27E” which designates the approved weight assumptions for airline passengers and baggage:

| | |
|---|---|
| Average passenger weight—summer | 190.0 lbs |
| Average passenger weight—winter | 195.0 lbs |
| Average bag weight | 28.9 lbs |
| Average heavy bag weight | 58.7 lbs |

Historical weather patterns regarding wind velocity and direction, along with storm patterns along scheduled airline routes are also considered when planning the amount of fuel that will be consumed for a potential flight. On the actual day of a flight, typically two hours prior to the departure of that flight, the airline's automated load planning program will be transferred to the desktop computer display of one of the airline's Flight Dispatchers. It is the responsibility of the Flight Dispatcher to then monitor the planned load of that flight as passengers check-in at the gate. Typically this process goes without interruption and the aircraft will dispatch on schedule, as planned. As the door of the aircraft is closed and the load is closed-out by the Flight Dispatcher, the planned load will always match the departure load, as submitted to the FAA, because both are based on the same compilation of weight assumptions. If there were a system onboard the aircraft that measures the aircraft weight, just as the aircraft door closes; and the measured weight did not match the calculated weight, the airline would be forced to take a departure delay to resolve the differential in the two separate but parallel weight determination processes. This potential for delay in the flight departure, on as many as 2,200 daily flights for a single airline, results in the various airlines not willing to take the risk of hundreds of flight delays. Airlines currently dispatch their aircraft under FAA approved procedures; a method which helps keep the airlines on schedule. This creates an incentive for airlines to continue to use the FAA approved assumed weights, irregardless to whether the assumed aircraft weight determination is accurate.

Airlines would appreciate an opportunity to use the CG tracking capabilities of today's aircraft weight and balance systems to more efficiently place baggage and cargo below decks, and take advantage of the reduced fuel consumption benefits; but are not willing to take the risk of scheduled departure delays when the aircraft's planned weight, built upon weight assumptions, does not match the aircraft's actual measured weight.

The methods described herein are applicable as alternatives to existing prior art aircraft weight and balance measuring systems for determining aircraft CG, independent of measuring the aircraft weight.

### SUMMARY OF THE INVENTION

Despite tremendous amounts of airline operational planning and procedural execution; unforeseen human factors still allow for a high frequency of unanticipated loads experienced by the aircraft landing gear.

This invention offers new methods and apparatus to monitor and indicate in real-time the range of loads being applied to the NLG and MLG of an aircraft, and used simultaneously by aircraft flight crew, as a tool to avoid unanticipated loads to the landing gear struts.

If through comparison, with the use of a look-up table, the range of pressure changes within the NLG struts are found to be nearing the higher limitation range, the aircraft flight crew member coordinating the passengers boarding and/or in-flight catering items deliveries onto the aircraft, the crewmember can temporarily halt passengers still on the jet-bridge from boarding the aircraft, or halt such heavier catering items awaiting to be loaded onto the aircraft.

If through comparison, with the use of a look-up table, the range of pressure changes within the NLG struts are found to be nearing the lower limitation range, the aircraft flight crew member coordinating the flow of passengers exiting from the aircraft, can temporarily halt passengers still within the aircraft from exiting.

There is provided a method of monitoring and indicating in real-time, the range of loads applied to the NLG, the aircraft flight crew having a means monitor the loads being applied to the NLG, to insure the NLG is not subjected to unanticipated loads. The steps to monitor loads applied to the NLG include: identifying the pressure within the NLG strut through continual monitoring of the NLG load indicator lights, use of a look-up table to compare the variations of measured pressures within the NLG struts to a number of pressure values associated with a known load values; as aircraft flight crew take actions to control the traffic flow of passengers and/or catering items to maintain suitable NLG loads.

### BRIEF DESCRIPTION OF THE DRAWINGS

Although the features of this invention, which are considered to be novel, are expressed in the appended claims; further details as to preferred practices and as to the further objects and features thereof may be most readily comprehended through reference to the following description when taken in connection with the accompanying drawings, wherein:

FIG. 1 is a side view of a typical regional aircraft, with a tricycle type landing gear in the extended position, supporting the weight of the aircraft, resting on the ground, illustrating the location of the aircraft longitudinal CG, and the aircraft Mean Aerodynamic Chord hereinafter referred to as MAC, along with various components of the preferred embodiment.

FIG. 2 is a side view of a typical aircraft telescopic landing gear strut, with various elements of the preferred embodiment attached to the landing gear strut.

FIG. 3 is a perspective view of the aircraft landing gear footprint, and how the aircraft CG is calculated.

FIG. 4 is a front view of a typical aircraft telescopic landing gear strut, with various elements of the preferred embodiment attached to the landing gear strut.

FIG. 5 is an example weight and balance control and loading chart.

FIG. 6 is a schematic diagram of the onboard computer with sensor inputs that support the CG calculation software programs of this invention.

FIG. 7 is a side view of a typical Boeing 737-800 aircraft, with a tricycle type landing gear in the extended position, supporting the weight of the aircraft, resting on the ground, illustrating checked bags located within the FWD and AFT baggage compartments and passengers crowding towards into FWD area of the aircraft cabin, transferring aircraft weight FWD and applying excessive loads to the aircraft NLG, along with various components of the preferred embodiment.

FIG. 8 is a side view of a typical Boeing 737-800 aircraft, with a tricycle type landing gear in the extended position, supporting the weight of the aircraft, resting on the ground, illustrating no passengers in the FWD portion of the cabin, passengers remaining in the AFT portion of the cabin, while connecting-flight checked bags have been removed from the FWD baggage compartment, thus transferring aircraft weight AFT from that shown in FIG. 7 and reducing aircraft NLG loads.

FIG. 9 is a side view of a typical Boeing 737-800 aircraft, with a tricycle type landing gear in the extended position, where too much weight has been removed from the NLG, and the aircraft has tipped AFT.

FIGS. 10a, and 10b are illustration of side views of a typical NLG strut, with FIG. 10a showing the strut in the full-telescopically compressed position, and FIG. 10b showing the strut in the full-telescopically extended position.

FIG. 11 is a view of an aircraft internal cabin, surface mounted, landing gear strut load indicator with audible alert, utilizing various colors of lamp bulbs, with the illumination of each specific lamp color being related to the real-time loads experienced by the aircraft landing gear strut, related to aircraft longitudinal CG.

FIG. 12 is a view of an aircraft internal baggage compartment, surface mounted, landing gear strut load indicator with audible alert, utilizing various colors of lamp bulbs, with the illumination of each specific lamp color being related to the real-time loads experienced by the aircraft landing gear strut, related to aircraft longitudinal CG.

FIG. 13 is a view of an aircraft MLG strut load indicator, designed for use by fuel loaders, utilizing various colors of lamp bulbs, with the illumination of each specific lamp color being related to the real-time loads experienced by the aircraft landing gear strut, related to aircraft lateral CG.

FIG. 14 is a schematic diagram of the onboard computer with sensor inputs that support calculation software programs of this invention for monitoring unanticipated landing gear loads.

FIG. 15 is a schematic diagram of the process design used by aircraft flight crew to monitor for unanticipated landing gear loads.

### DETAILED DESCRIPTION OF THE PREFERRED EMBODIMENT

The present invention provides to the aircraft flight crew real-time indications of the variations in load being experienced by each respective aircraft landing gear strut, to allow actions to be taken by the aircraft flight crew, aircraft ground crew, and aircraft fuel loaders, to monitor and avoid unanticipated loads. Such unanticipated loads include excessive loads on the NLG when loading the aircraft, as well as excessive loads aft when unloading the aircraft, which excessive aft loads could lead to tipping the aircraft aft. Such unanticipated loads also include unequal lateral loads on the MLG when loading fuel in the wing tanks. Personnel can use the indicated information to continue with loading operations, or if the aircraft begins to experience unanticipated loads, then the personnel can alter the loading procedure to allow for more balanced and correct lading. For example, if a flight attendant in the cabin becomes aware of overloading on the NLG during passenger embarkation, that flight attendant can take steps to slow the embarkation of passengers onto the aircraft. As another example, if a baggage handler in one of the baggage compartments becomes aware of weight shifting toward aft toward a possible tipping, the baggage handler can take steps to compensate by slowing baggage movement onto or off or the aircraft.

The present invention, properly monitored by airline personnel, accomplishes this task without disrupting aircraft operations.

By providing a real time indication of loads experienced by the landing gear and airline personnel actions to avoid situations that might lead to unanticipated landing gear loads, the overall operational safety of the aircraft is enhanced.

The real time indications of loads allow the flight crew to take corrective action before a problem develops. The real time indications also allow the flight crew to see the results of their corrective actions.

The present invention monitors loads applied to the landing gear during loading events. During a loading event, the aircraft is on the ground, with all landing gear deployed and supporting the aircraft on the aircraft. The aircraft is in operation, taking on passengers, baggage, cargo, supplies and fuel, or in the alternative, discharging passengers, baggage, cargo and waste materials such as trash. One example of a loading event is an aircraft parked at a passenger bridge, with passengers and baggage entering the aircraft. Caterers are also loading supplies such as food, beverages, ice, etc. Fuel may be loaded onto the aircraft. The aircraft is being prepared for take-off. Another example of a loading event is an aircraft again parked at a passenger bridge, with passengers and baggage leaving the aircraft after the aircraft has landed.

An aircraft is typically supported by plural landing gear struts. In many if not most cases, the aircraft is supported by three landing gear struts. Each landing gear strut is designed much like and incorporates many of the features of a telescopic shock absorber. The shock absorber of the landing gear strut comprises internal fluids of both hydraulic oil and compressed nitrogen gas. More simply said the weight of an aircraft rests on three pockets of compressed nitrogen gas. Pressure contained within the landing gear struts is measured in “psi”.

The present invention offers methods to determine aircraft Center of Gravity (CG) by measurement of strut pressure, independent of determining the aircraft weight. Tracking the aircraft CG can be accomplished by determining the relationship or a ratio of the internal gas pressure contained within the nose landing gear strut, as compared to the combined pressure contained within both main landing gear struts. Typically the nose landing gear supports about 8%-14% of the aircraft weight/load, where the remainder of the weight/load is supported by the combined main landing gear. Each of the two opposing main landing gear struts have identical load supporting surface area dimensions, where the smaller nose landing gear strut is typically sized to about 30% of the load supporting surface area, as compared to each of the main landing gear struts.

By measuring the internal gas pressure within each landing gear strut, and applying a adjustment/reduction value to the nose gear pressure, which adjustment/reduction value is proportional to the smaller load supporting surface area within the nose landing gear; then comparing the adjusted nose landing gear pressure to the combined main landing gear pressure, the aircraft CG can be measured and identified without the need to determine aircraft weight.

Additionally the present invention offers methods to determine aircraft CG by measurement of landing gear strut component yielding/bending, though measurement of changes in voltage from attached strain gauge sensors corresponding to changes in applied load to the respective landing gear, without the need to determine aircraft weight.

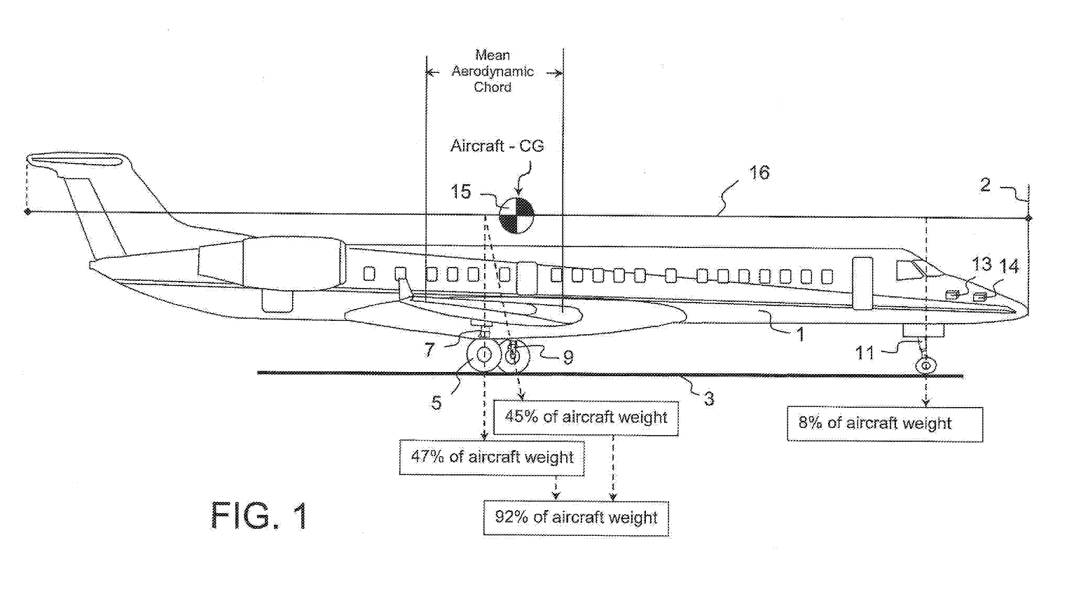

Referring now to the drawings, wherein like reference numerals designate corresponding parts throughout the several views and more particularly to FIG. 1 thereof, there is shown a typical regional aircraft 1. All variations of aircraft are required to have a vertical “datum line” 2 which is a non-changeable reference point, designated by the aircraft manufacturer, which is used in calculations of the aircraft CG 15. (the CG 15 is located inside of the aircraft 1, but in this illustration is shown above aircraft 1, for better visibility) Aircraft CG 15, as measured along aircraft longitudinal axis 16, can be referenced in various ways by different airline operations. As an example, units of measure can be referenced in inches or in centimeters, measured aft of the aircraft datum line 2. This form of reference is referred to as the CG 15 located at a particular “station number” for the aircraft 1. As an additional example, the location of aircraft CG 15 may be referenced at a location measured as a percentage of the distance from the leading edge of the aircraft's Mean Aerodynamic Chord (% MAC).

The MAC is the average (Mean) width of the wing's lifting surface (Aerodynamic Chord). In the case of a swept-wing aircraft 1, the leading edge of the MAC is locative just aft of the leading edge of the wing where it attaches to the aircraft 1. The trailing edge of the MAC is located just forward of the aft wing-tip. Airline operations often reference the aircraft CG location as a point some percentage aft of the forward edge of the mean aerodynamic chord, or as % MAC.

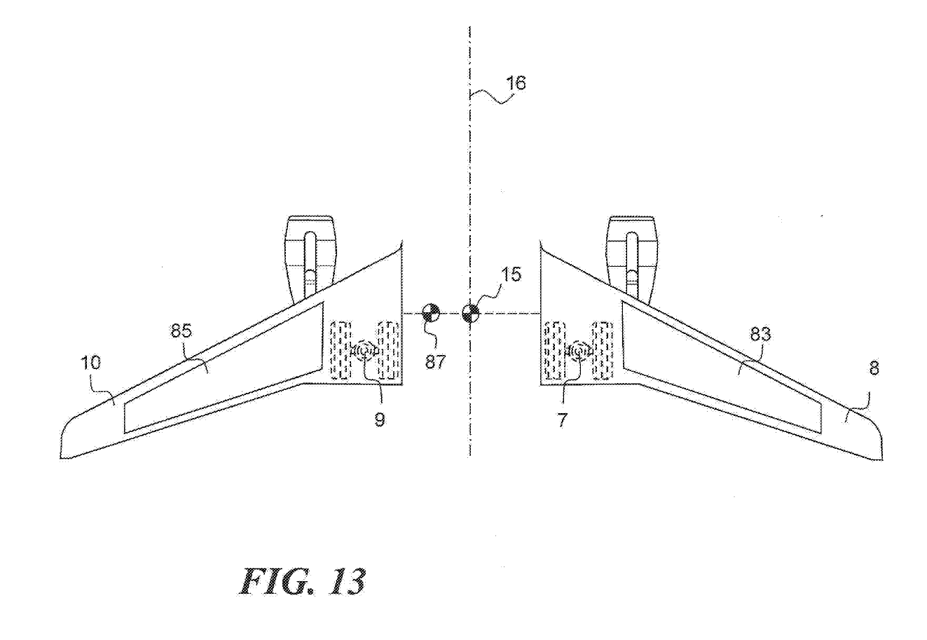

Aircraft 1 has a tricycle landing gear configuration consisting of a nose landing gear 11, and also shown two identical main landing gears including a right main landing gear 7 and a left main landing gear 9. Main landing gears 7 and 9 are located at the same point along the aircraft's horizontal axis 16, but for convenience in this illustration, are shown in a perspective view for this FIG. 1. Main landing gear 7 and 9 typically support an equalized amount of weight, but in this example where an aircraft fuel load imbalance has distributed more fuel into the starboard/right wing-tank than the port/left wing-tank, causing an unbalanced amount of weight applied to main landing gear 7 and 9. Thus the illustration shows 47% of the aircraft weight assigned to right main landing gear 7 and 45% of the aircraft weight assigned to left main landing gear 9 with the remaining 8% is supported by nose gear 11. A main landing gear load indicator (more fully described and illustrated in FIG. 13) can be used by aircraft fuel loaders to insure aircraft fuel is equally distributed within the port and starboard wing fuel tanks.

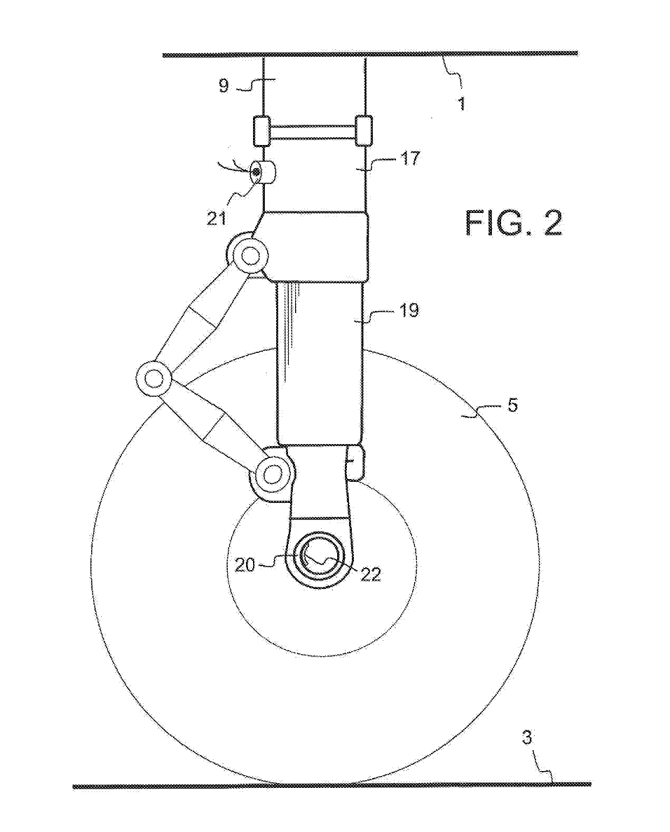

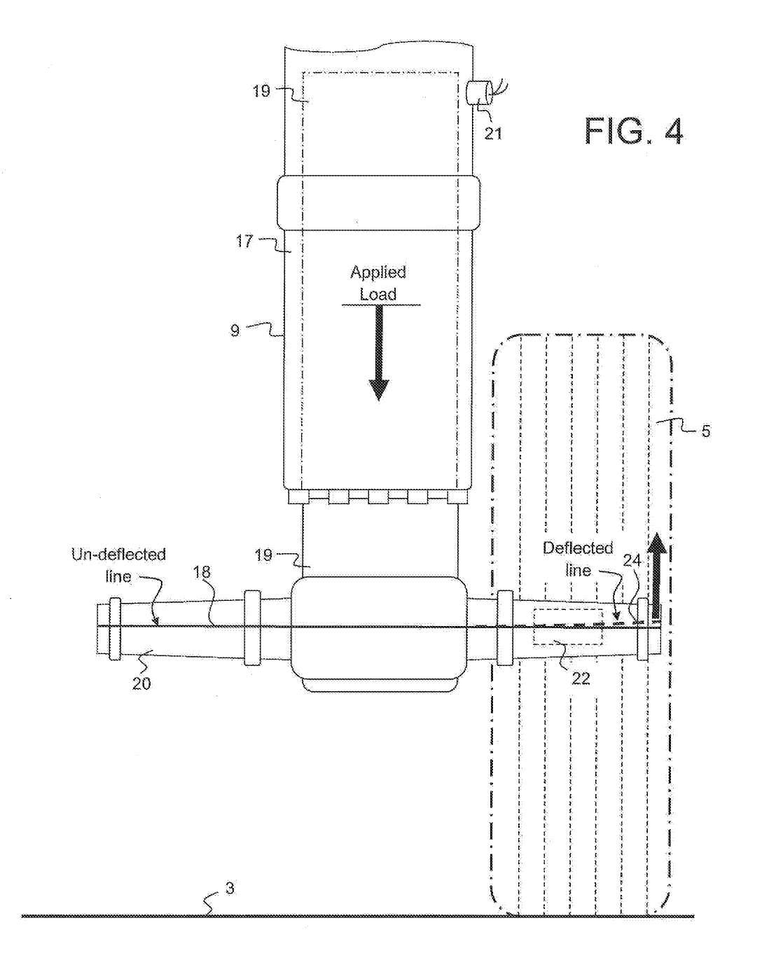

Landing gear 7, 9 and 11 incorporate one or more tires 5 to distribute the weight of aircraft 1 which is resting on the ground 3. Electronic elements which together are used in this invention, and are attached to aircraft 1, are an aircraft CG 15 measurement computer 13, aircraft inclinometer 14, landing gear strut pressure sensors 21 with embedded temperature probes (shown in FIG. 2 and FIG. 4), and landing gear axle deflection strain gauge sensor 22 (shown in FIG. 2 and FIG. 4). Computer 13 contains various internal circuit boards for processing calculations for aircraft CG 15, and makes refinements in calculation of aircraft CG 15, from possible variation in aircraft 1 incline, due to possible slope in ground 3.

The use of regional aircraft is by way of an example, as the apparatus and methods described herein can be used on most types of aircraft which utilize pressurized, telescopic landing gear struts.

Referring now to FIG. 2 there is shown a side view of a typical aircraft telescopic landing gear strut 9, further identifying landing gear strut cylinder 17, in which strut piston 19 moves telescopically within strut cylinder 17. Pressure and temperature within main landing gear 9 is monitored by a pressure/temperature sensor 21. Load from tire 5 is transferred to piston 19 through axle 20. Deflection of axle 20 is measured by strain gauge sensor 22.

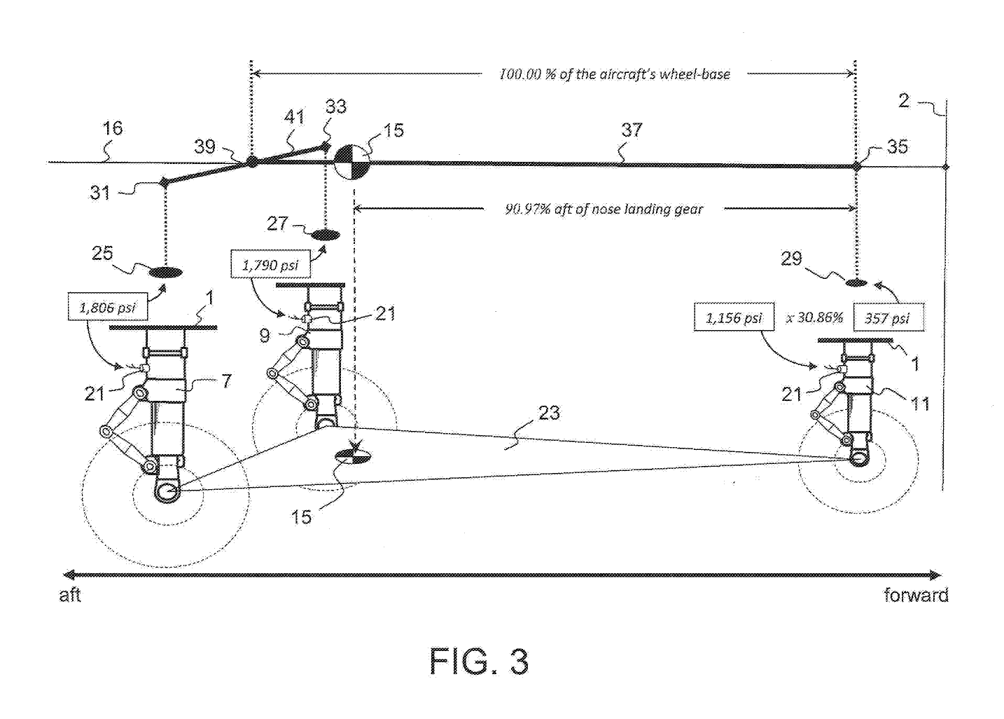

Referring now to FIG. 3, there is shown a perspective view of the aircraft's 1 landing gear footprint, being nose landing gear 11 in relation to right main landing gear 7 and left main landing gear 9, and how the three corners of an imaginary triangular horizontal plane 23 are created by the three landing gear struts 7, 9 and 11. The corners of the horizontal plane 23 are located at a reference point on each strut, such as the vertical center-line of the wheel axles.

Located directly above right main landing gear 7 is a black circle 25 (shown in this perspective view as an oval) which represents the load supporting surface area of the piston within right main landing gear strut 7. Located directly above left main landing gear 9 is a black circle 27 (shown as an oval) which represents the load supporting surface area of the piston within left main landing gear strut 9. Located directly above the nose landing gear 11 is a smaller black circle 29 (shown as an oval) which represents the lesser amount of load supporting surface area of the piston within the smaller nose landing gear strut 11. The circles 25, 27 and their associated pistons are of equal size to one another, while the circle 29 and its associated piston is smaller in size.

Located directly above right main landing gear black circle 25 is reference point 31 which represents the geographic center of the load supporting surface area within right main landing gear strut 7. Located directly above left main landing gear black circle 27 is reference point 33 which represents the geographic center of the load supporting surface area within left main landing gear strut 9. Located directly above nose landing gear black circle 29 is reference point 35 which represents the geographic center of the load supporting surface area within nose landing gear strut 11. The position of point 35, which is located aft from the datum line 2 (also shown in FIG. 1) is a known value. Line 37 extends along and parallel to the aircraft's horizontal axis 16 and intersects line 41 at point 39 which identifies a location that is equal-distance between right main landing gear 7 and left main landing gear 9. Line 41 is perpendicular to line 37. Though line 37 and aircraft's horizontal axis 16 are coaxial or parallel, line 37 is the measured distance between nose gear 11 and the perpendicular line 41 between main landing gears 7 and 9.

In FIG. 3, the black and white patterned disk representing aircraft CG 15 identifies the longitudinal location of aircraft CG 15 along line 37. In addition to identifying the aircraft's longitudinal CG 15, a determination is made of main strut pressure asymmetry by comparing the pressure of right main landing gear 7 to the pressure of left main landing gear 9. The lateral location of the CG 15 is tracked and may be identified off-center from the aircraft's longitudinal axis 16. CG 15 is also monitored as it moves (or a projection thereof) laterally across horizontal plane 23.

The aircraft CG 15 is measured using the relationships of aircraft landing gear strut pressures alone, as opposed to the determination of the aircraft's measured weight. It shall be assumed all strut pressure measurements will be corrected for variations in temperature, as measured by a temperature probe feature of pressure sensor 21. Aircraft landing gear struts are designed for various loads and endurance. The main landing gear is designed to withstand the extreme loads associate with very hard landing events, thus the main landing gear must be sized larger, to withstand extreme landing loads. The nose landing gear absorb much less of the landing loads during each landing event, where the responsibility of the nose landing gear is for basic aircraft balance of about 8-14% of the aircraft weight; and used to steer the aircraft while on the ground. The differential in size between the main landing gear struts and the nose landing gear strut requires the measured pressure from the nose landing gear strut to be adjusted in the determination of aircraft CG when using strut pressure alone. Considering the aircraft nose landing gear 11 is smaller than either main landing gear 7 or 9, a typical calculation of CG 15 through direct comparison of measured “psi” values from the three respective landing gear struts would find error in the CG 15 determination. Adjusting or compensating for the reduced load supporting surface area of the nose landing gear, as illustrated by the smaller black circle 29, allows for determining aircraft CG 15 using strut pressure alone, without measuring the weight of the aircraft.

In the preferred embodiment, the method for determining a correct nose gear strut 11 pressure adjustment/reduction value is to divide the load supporting area of the nose landing gear strut (as represented by circle 29), by and as a percentage of the load supporting surface area of either main landing gear strut 7 or 9 (as represented by circle 25 or 27) to create a proper adjustment/reduction value for nose gear strut 11 pressure,

SA_{N}÷SA_{RM}%=ADJ_{N}%

where SA_{N} is the load supporting area within the nose strut;
SA_{RM} is the load supporting area within the right main strut (left main strut could be used):
ADJ_{N}% is the adjustment value to be applied to measured nose strut pressure.
   The adjustment factor ADJ_{N}% need only be determined once for the aircraft, unless the landing gear load supporting dimensions are changed. The adjustment factor ADJ_{N}% is used every time CG is determined.

To determine CG, the pressure of the nose strut is then adjusted:

P_{N}×ADJ_{N}%=P_{NADJ}

where P_{N} is the measured strut pressure within the nose strut;
P_{NADJ} is the adjusted strut pressure assigned to the nose landing gear strut.

The pressures of the main struts are totaled:

P_{RM}+P_{LM}=P_{MTOTAL}

where P_{RM} is the measured strut pressure within the right main strut;
P_{LM} is the measured strut pressure within the left main strut;
P_{MTOTAL} is the total pressure of the main struts.

An adjusted total strut pressure is determined:

P_{MTOTAL}+P_{NADJ}=P_{ADJTOTAL}
where P_{ADJTOTAL} is the total pressure of the combined main gear struts plus the adjusted pressures of the nose gear strut.

The center of gravity is determined:

P_{MTOTAL}÷P_{ADJTOTAL}%=CG
Continuing with the example, the diameter of the main piston is 6.3 inches and the diameter of the nose piston is 3.5 inches:

SA_{N}÷SA_{RM}%=ADJ_{N}%

9.62 in²÷31.17 in²%=30.86%

1,156×30.86%=357 psi=P_{NADJ}
where 1,156 is the measured pressure within the nose landing gear and 357 is the adjusted pressure.

As illustrated in FIG. 3, 100% represents the full wheel base, or distance between points 35 and 39. The aircraft CG 15 is located 90.97% aft of point 35 (of the aircraft wheel base), where aircraft CG 15 is located 90.97% along the measured length of line 37. Point 35 is the center of nose gear 11. The length of line 37, from point 35 to point 39, does not change. The offset, or distance, from point 35 to the datum line 2 is known, thus the location of CG 15 is relative to the datum line, and can be determined.

The “adjusted pressure value” of 357 psi for the nose landing gear strut pressure is required to correctly determine the location of aircraft CG when using strut pressure alone. Determination of aircraft CG is a function of identifying and applying the ratio of the adjusted nose landing gear strut pressure, as compared to combined main landing gear strut pressures where:
P_{RM}=Pressure of the Right Main landing gear strut
P_{LM}=Pressure of the Left Main landing gear strut
P_{MTOTAL}=Pressure of the Total Main landing gear struts
1,806 psi=P_{RM}
1,790 psi=P_{LM}
1,806 psi+1,790 psi=3,596 psi=P_{MTOTAL}
3,596 psi+357 psi=3,953 psi=P_{ADJTOTAL}
3,596 psi÷3,953 psi %=90.97%=CG location, aft of Nose landing gear strut

The determined CG location is a percentage of the distance from the nose landing gear, to the location of the main landing gear. To make this CG determination which is based on aircraft wheel-base dimension more practical for use by an airline operator, the CG determination may be converted into a value of % MAC, which is a corresponding value in reference to a point associated a percentage value located aft of the leading edge of the aircraft's Mean Aerodynamic Chord. A simple look-up table is created which relates % wheel-base to that of % MAC. Additionally a simple look-up table is created which relates % wheel-base to that of a corresponding value in relation to an aircraft station number.

The location of the CG 15 which may be off-center to the longitudinal axis 16 is determined by identification of the differential in pressure measurements of the main landing gears 7 and 9. A differential of zero locates the CG 15 as along the longitudinal axis 16. A higher pressure on one main strut locates the CG 15 on that side of the axis 16, by a distance proportional to the magnitude of pressure differential. A look up table can be used.

Referring now to FIG. 4 there is shown a front view of a typical aircraft telescopic landing gear strut 9 further identifying landing gear strut cylinder 17, in which strut piston 19 moves telescopically within strut cylinder 17. Landing gear strut piston 19 uses axle 20 to allow tire 5 to transfer aircraft load to the ground 3. Pressure within main landing gear 9 is monitored by a pressure sensor 21. Pressure measured by pressure sensor 21 is proportional to the amount of applied load onto landing gear 9. The applied load to landing gear 9 can also be measured by an axle deflection sensor 22. Axle deflection sensor 22 can be of the strain gauge variety, which measures the vertical deflection of axle 20. A bold solid line 18 is shown running horizontal across the center-line of landing gear axle 20 and represents an un-deflected posture of the landing gear axle 20. As load is applied, axle 20 will deflect. A bold dashed line 24 representing deflection of axle 20 is shown running adjacent to the un-deflected bold solid line 18. The amount of deflection of landing gear axle 20 is directly proportional to the amount of load applied. As load is applied to strut 9, the increase in load will be immediately sensed by strain gauge sensor 22.

As previously described in FIG. 3, the main landing gear are larger than the nose landing gear. This pattern continues with the sizing of landing gear axle 20. The nose landing gear axle 20 is smaller than the main landing gear axle 20. Strain gauge sensor 22 measures the vertical deflection of axle 20, where the amount of axle deflection is equivalent to the amount of applied load.

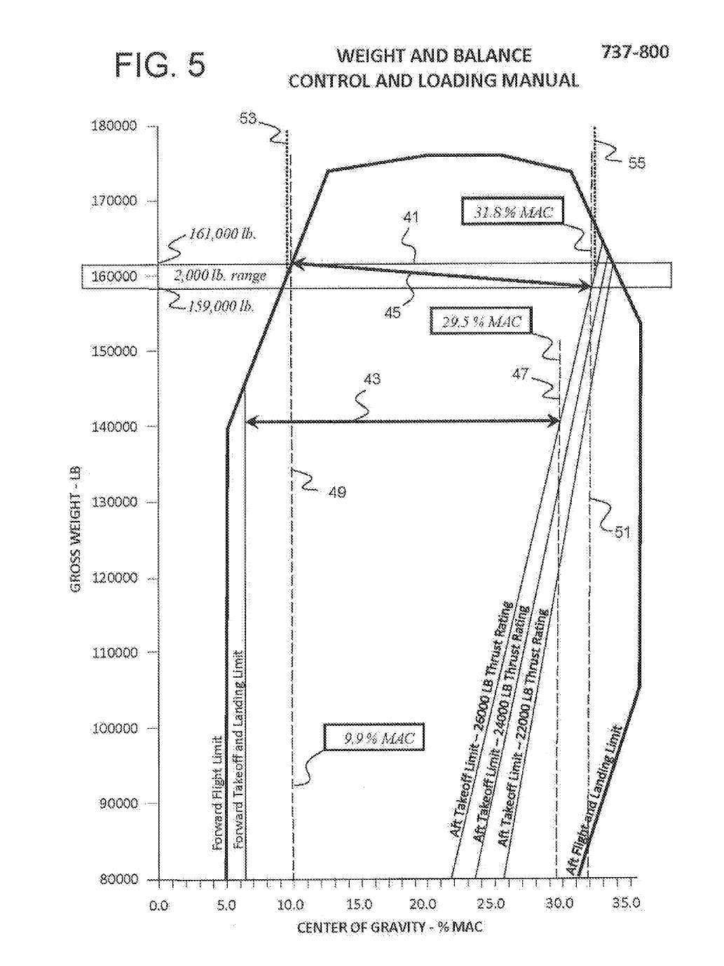

In a similar manner to the nose strut pressure adjustment previously described, an adjustment value is used to refine the measured voltage output from the nose strain gauge sensor 22. As strain gauge sensor 22 deflects under load, represented by axle 20 deflection, the voltage output from strain gauge sensor 22 will change in proportion to the sensor 22 deflection. Measure voltage changes from nose gear sensor 22 representing axle deflection are adjusted, to compensate for the smaller size of the nose landing gear axle, as compared to the size of the main landing gear axle. Strain gauge sensor 22 will transmit a voltage pattern proportional to the amount of axle 20 deflection, to the system computer 13 (shown in FIG. 1 and described in FIG. 5). A software look-up table is generated to correct measured voltage values received from nose strut sensor 22, for the further determination of aircraft CG.

Typically, in prior art weight and balance systems, the voltage transmitted from strain gauge sensor 22 is converted to an amount equivalent to the applied weight, at each landing gear strut. In the present invention, the voltage of the measured axle deflection from the nose landing gear is adjusted, then compared directly to the voltage of the measured axle deflection of the combined main landing gear; where the voltage measure from the deflection of the nose gear axle will be corrected in proportion to the reduced size of the nose gear axle, as compared to the main landing gear axle; to further determine aircraft CG.

Referring now to FIG. 5, there is shown an example of the Boeing 737-800 “WEIGHT AND BALANCE CONTROL AND LOADING MANUAL” chart, typically referred to as the aircraft weight and CG envelope. The weight and CG envelope define the forward and aft CG limitations in which the aircraft can safely operate. The forward and aft CG limits of safe operation will vary depending on the amount of aircraft weight, and the amount of engine thrust used during the takeoff roll.

As previously described, many airlines determine aircraft weight using assumed weight values based on historical weight data for various items such as passengers, baggage and cargo loaded onto the aircraft, where the pre-determined and measured empty aircraft weight is associated with the sum of the assumed weights of the accumulated items loaded onto the aircraft, without the need to physically place the aircraft on weighing scales.

An acceptable “range” of aircraft weight can be associated with variations in landing gear strut pressures. The aircraft is placed onto aircraft weighing scales, which measure the weight supported at each respective landing gear strut. The measured pressure from each respective landing gear strut is recorded and stored within a look-up table, as each respective pressure relates to the weight recorded by each respective scale. While the aircraft remains on scales, the aircraft weight is increased and decreased creating different strut pressures to corresponding scale measurements. The look-up table is expanded to a determine aircraft weight ranges from the lower empty weight of the aircraft, up to the higher maximum take-off weight of the aircraft. This look-up table creates a data-base of aircraft weight range determinations as they relate to associated pressures within each landing gear strut. Subsequently when the aircraft is in daily operations, the aircraft CG is measured as described in FIG. 3, and a range of aircraft weight is determined from the respective landing gear struts pressures, to further verify the measure aircraft CG is located within the associated limitations of the current aircraft weight range.

As an example, the horizontal line 43 illustrates the forward and aft CG limitations of an aircraft having an accurate or measured weight of 140,000 pounds. The forward CG limitation of 6.5% MAC, illustrated by the “Forward Takeoff and Landing Limit” line; and an aft CG limit of 29.5% MAC, illustrated by vertical dashed line 47 (with a thrust rating of 26,000 pounds).

As an alternate example, the aircraft weight can be determined within an acceptable range for the further determination of acceptable CG limitations within FAA Regulatory requirements; but such weight determination would not be accurate enough, thus unacceptable to FAA Regulatory requirements as a means to measure aircraft weight prior to take-off for a flight. For this example the weight range is 160,000 lb., where box 41 illustrates a range of 2,000 lb. representing a potential error of ±1,000 lb. in the aircraft weight determination. The forward and aft CG limitations are illustrated by the bold diagonal line 45, having a forward CG limit of 9.9% MAC, illustrated by vertical dashed line 49 and an aft CG limit of 31.8% MAC, illustrated by vertical dashed line 51. Line 45 is shown as diagonal due to a curtailment of the forward and aft CG limits associated with the ±1,000 lb. range of the weight determination. Vertical dotted line 53 illustrates the forward CG limit for the aircraft with a weight determination of exactly 160,000 lb. Vertical dotted line 55 illustrates the aft CG limit for the aircraft with a weight determination of exactly 160,000 lb. There is negligible difference between the locations of line 53 representing the forward CG limit using accurate aircraft weight, to that of line 49 using an aircraft weight range. There is negligible difference between the locations of line 55 representing the aft CG limit using accurate aircraft weight, to that of line 51 using an aircraft weight range. The negligible difference in determination of forward and aft aircraft CG limitations, based upon determination of the aircraft weight range, allows for aircraft weight determinations be made within some pre-determined acceptable range, resulting is forward and aft CG limitation curtailments which are extremely minimal.

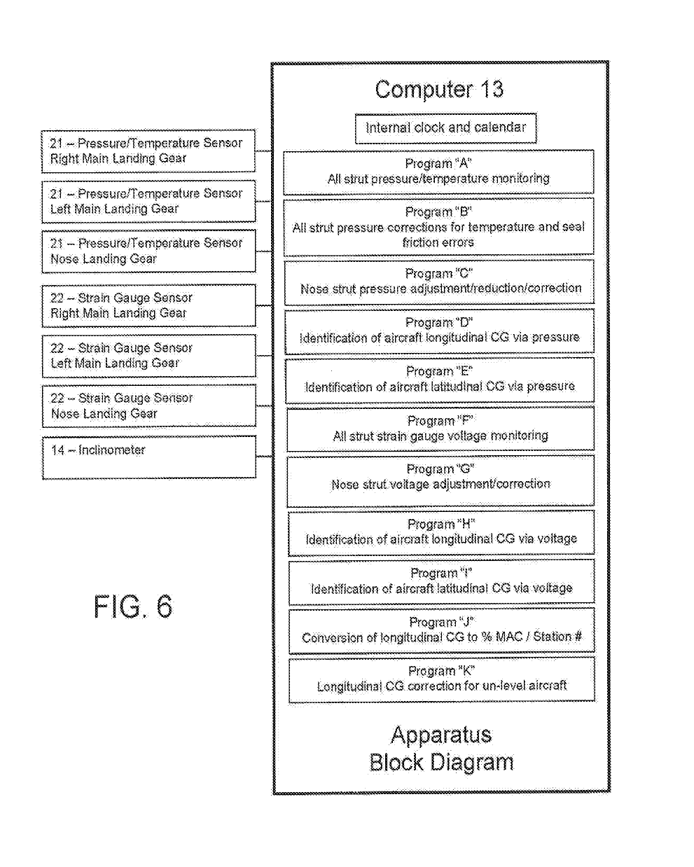

Referring now to FIG. 6, there is shown a block diagram illustrating the apparatus and software of the invention, with multiple (nose, left-main and right-main landing gear) pressure/temperature sensors 21 which supply landing gear strut pressure/temperature data inputs into CG computer 13. Additionally, multiple (nose, left-main and right-main landing gear) strain gauge sensors 22 supply voltage data inputs corresponding to landing gear strut axle deflection into CG computer 13. Inclinometer 14 monitors any changes in the aircraft angle in relation to horizontal, and supply aircraft angle data as additional inputs to Computer 13. Computer 13 is equipped with an internal clock and calendar to document the time and date of stored data.

Computer 13 has multiple software packages which include:
Program “A”—a software routine for monitoring aircraft landing gear strut pressure/temperature.
Program “B”—a software routine for monitoring aircraft landing gear strut pressure, to further correct pressure distortions related to temperature and landing gear strut seal friction errors. The complete disclosure of U.S. Pat. Nos. 5,214,586 and 5,548,517 are incorporated by reference.
Program “C”—a software routine for adjusting/reducing/correcting the measured nose landing gear strut pressure, as related to a proportional reduction in the size of the nose landing gear strut's load supporting surface area, as compared to the size of a main landing gear strut's load supporting surface area.
Program “D”—a software routine for combining the pressure values associated with each main landing gear strut, as compared to the adjusted pressure of the nose landing gear strut; to further calculate and identify the aircraft longitudinal CG.
Program “E”—a software routine for identifying differential pressure values associated with each main landing gear strut, to further calculate and identify any asymmetrical pressure from the corresponding main landing gear struts, to further identify aircraft lateral CG.
Program “F”—a software routine for monitoring variations in voltage from strain gauge sensors attached to the aircraft landing gear axles.
Program “G”—a software routine for adjusting/correcting the measured voltage representing nose landing gear axle deflection, as related to a proportional adjustment for the smaller size of the nose landing gear axle, when compared to the size of a main landing gear axle.
Program “H”—a software routine for identifying combined voltage values associated with each main landing gear strut, as the total main landing gear voltage is compared to the adjusted voltage of the nose landing gear strut; to further calculate and identify the aircraft longitudinal CG.
Program “I”—a software routine for identifying differential voltage values associated with each main landing gear strut, to further calculate and identify any differential voltage from the corresponding main landing gear struts, to further identify aircraft lateral CG.
Program “J”—a software routine for where a look-up table is generated and subsequently used to convert the measured aircraft CG in relation to a percentage of the distance between the nose landing gear to the main landing gear; to an associated and equivalent value as measured as % MAC, and aircraft Station Number.
Program “K”—a software routine for identifying aircraft incline that is differential from horizontal, then correcting the measured and calculated CG of the un-level aircraft, to that of a level aircraft.

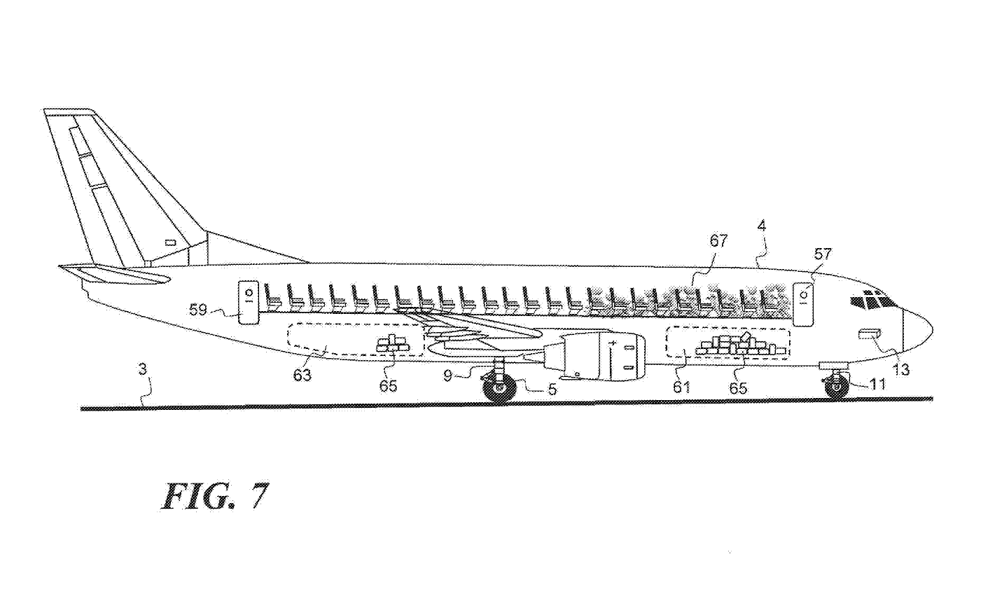

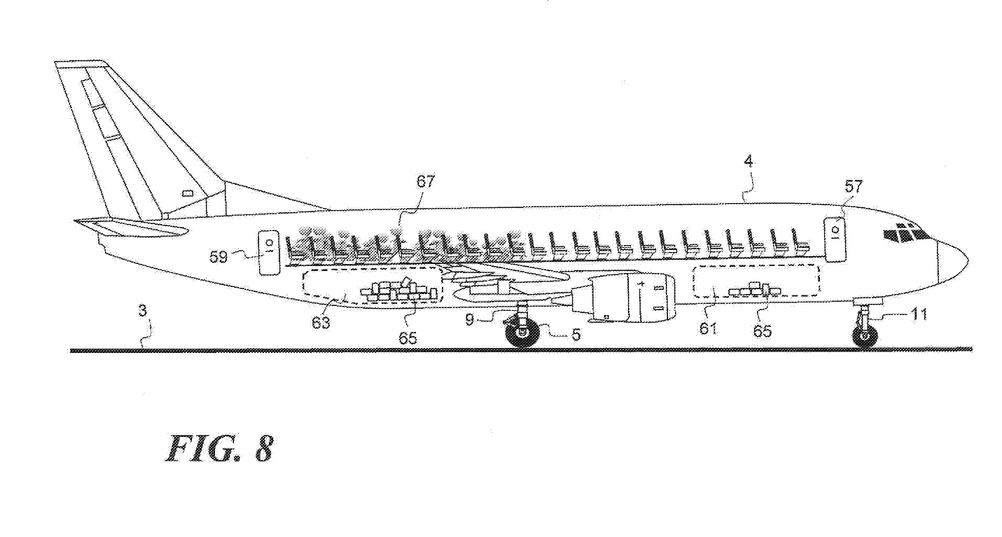

Referring now to FIG. 7 there is shown a side view of a typical Boeing 737-800 transport category aircraft 4, supported by tricycle landing gear configuration consisting of a nose landing gear (“NLG”) 11, and two identical main landing gears, including a Left-port Main Landing Gear (“LMLG”) 9 and a Right-starboard Main Landing Gear (“RMLG”) 7. Both LMLG 9 and RMLG 7 are positioned at the same location longitudinally along the aircraft 4. In this illustration LMLG 9 is behind RMLG 7. The aircraft shown is for exemplary purposes, as the prudent invention can be practiced on a aircraft having tricycle landing gear.

Landing gears 7, 9 and 11 distribute the weight of aircraft through tires 5, which in this illustration rest on the ground 3. Aircraft 4 has a forward baggage compartment 61 and an aft baggage compartment 63.

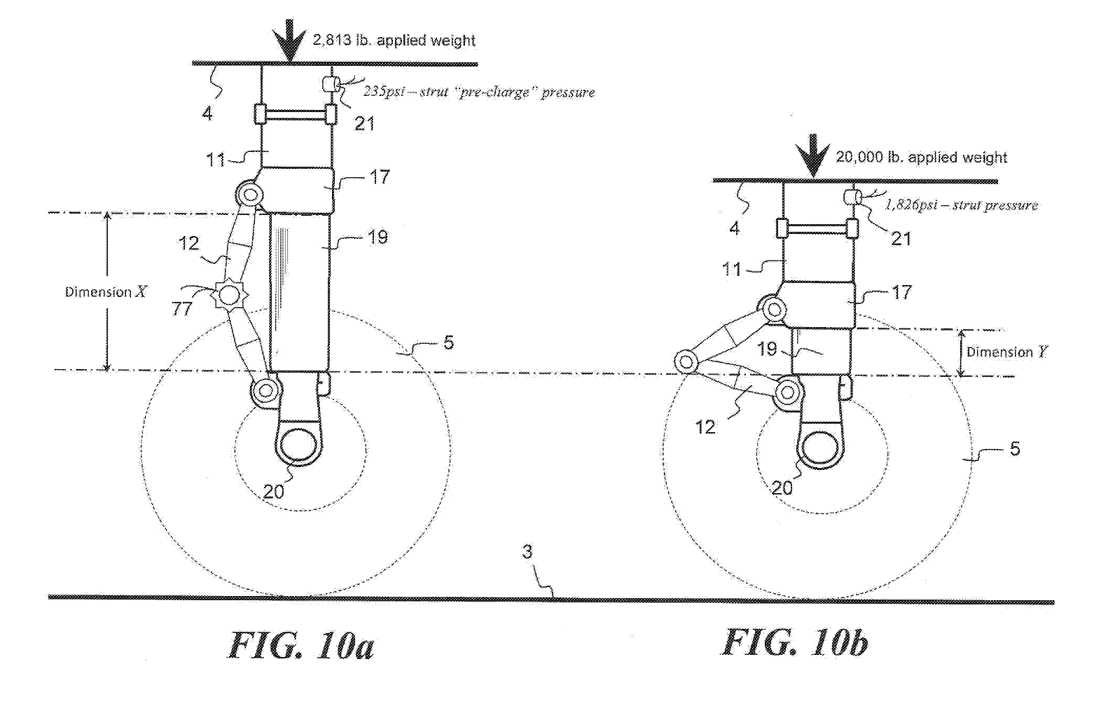

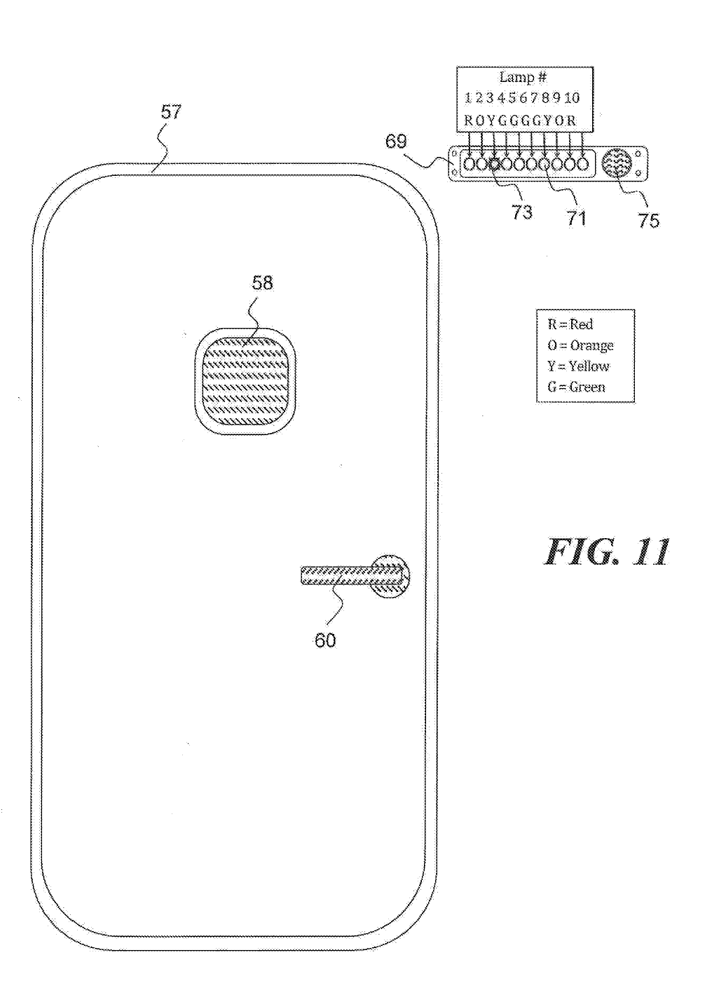

Electronic elements which are used in this invention, and are attached to aircraft 4, include an on-aircraft data acquisition computer 13, landing gear pressure sensors 21 (Shown in FIG. 10a and FIG. 10b) and a landing gear load monitoring indicator/display 69 (shown in FIG. 11) allowing members of the flight crew a means to monitor in real-time the landing gear load information, and further allow flight crew to better control the locations and rate at which passengers and baggage enter or exit the aircraft. On-aircraft computer 13 contains various internal circuit boards for the collection of strut pressure data from respective landing gears 7, 9 and 11. On-aircraft computer 13 is capable of wireless communication with a variety of corresponding computers and displays, not attached to the aircraft. The computer 13 is shown in the nose area of the aircraft, but the computer can be located elsewhere.

The Boeing 737-800 aircraft FWD baggage compartment 61 is twenty-five feet in total length. The AFT baggage compartment 63 is thirty-six feet in length. In this illustration FWD (forward) baggage compartment 61 illustrates a high number of checked bags 65, indicating this is most-likely a short connecting flight, where passengers 67 will be making a stop to changes planes in order to reach their final destinations. Many if not most of the bags in FWD baggage compartment 61 will be removed and sent to other aircraft used as continuations of flights to the various destinations of passengers 67. AFT baggage compartment 63 has the lower concentration of checked bags 65, as these are the bags that remain on this aircraft 4, until it reaches its final destination. The FWD baggage compartment 61, allows baggage loaders more ease in depositing and retrieving bags related to passenger who have connecting flights. Just as the aircraft arrives to the gate, baggage loaders quickly remove those bags associated with connecting passengers, to help assure the bags make it to the passenger's connecting flight.

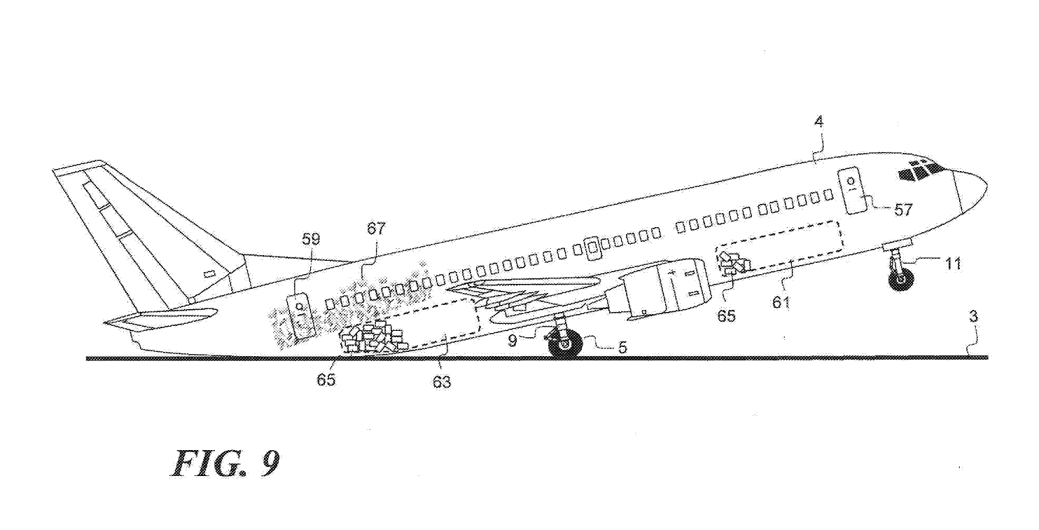

When the numerous bags are removed from in the FWD baggage compartment 61, a significant amount of weight/load is removed from the NLG 11. If the passengers 67 who were located within the FWD portion of the cabin exit aircraft 4, while at the same time some passengers seated near the middle of the cabin of aircraft 4, take additional time to remove their carry-on baggage from the over-head bins; the FWD section of the aircraft 4 cabin can become vacant, with all passengers having exited the aircraft 4, resulting in all of the remaining passengers, their carry-on bags and AFT baggage compartment 63 check bags 65 to still be situated behind the MLG 7 and 9. This will create unanticipated loads to the aircraft landing gears, 7, 9 and 11; causing the aircraft CG to move AFT (see FIG. 8) and further for aircraft 4 to tip (see FIG. 9). The aircraft flight crew can avoid the aircraft tipping, by monitoring the NLG load monitor display 69 (see FIG. 11), and using that real-time information to halt passengers while still waiting inside aircraft 4 and prevent them from exiting at the front door 47 of aircraft 4. This will allow additional time for more passengers to move FWD inside the cabin; transferring significant loads onto the NLG 11 and verification that the NLG loads are now sufficient to avoid the aircraft CG 15 from moving AFT to a point creating a scenario where the aircraft is too tall heavy in which the aircraft could tip, causing structural damage to the aircraft 4. Monitoring the measured loads applied to aircraft NLG 11 allows for an increased level of safety.

In addition, aircraft 4 is shown in this FIG. 7 with an excess number of passengers 67 located in the FWD section of the cabin, as they are boarding aircraft 4, thus applying unanticipated and excessive loads to NLG 11. Through monitoring NLG 11 load indicator 69 (see FIG. 11) aircraft flight crew can verify before NLG 11 loads become excessive, and delay passengers from boarding aircraft 4, until such time as passengers 67 already on the aircraft can move AFT, thus reducing the loads on NLG 11.

Referring now to FIG. 8 there is shown a side view of aircraft 4 with an excessive number of passengers 67 remaining within the AFT section of the cabin, and at the same time the airline baggage loaders have removed all of the connecting checks bags 65 from the FWD baggage compartment 61. No part of the airline flight crew or ground operations personnel can recognize this unanticipated and extremely light amount of loads remaining on NLG 11, without some type of real-time visual or audible indication (described in more detail relative to FIG. 11).

Referring now to FIG. 9 there is shown a side view of aircraft 4 tipped AFT, due to all of the connecting checks bags 65 having already been removed from the FWD baggage compartment 61. This has resulted in the aircraft CG moving extremely AFT, and aircraft 4 tipping onto its tail. During the tip, checked bags 65 within AFT baggage compartment 63 have slid AFT. During the tip, checked bags 65 within FWD baggage compartment 61 have slid AFT, further shifting the CG AFT. During the tip, remaining passengers 67 waiting and standing within the aisles have fallen further back, into the extreme AFT section of the cabin. Airline emergency personnel will then attempt to remove remaining passengers 67 out of AFT aircraft door 59.

Such tipping is not desired for a variety of reasons. Passengers onboard can be injured when the aircraft unexpectedly tips backwards. Passengers are standing in the aisle, moving baggage and are not prepared for a sudden inclination of the floor. Also, the aircraft itself may experience damage from the tail section contacting the ground. A tipping occurrence also results in the aircraft being removed from service for inspection.

Referring now to FIG. 10-a and FIG. 10b which each illustrate apparatus used to measure and monitor loads applied to the landing gear, where there is shown a side view of a typical aircraft telescopic NLG 11, comprising the landing gear strut cylinder 17, in which strut piston 19 moves telescopically within strut cylinder 17. A pressure sensor 21 monitors pressure within NLG 11. All weight supported by tire 5 is transferred through axle 20, to piston 19, resulting in variations to NLG 11 internal pressure, as recorded by pressure sensor 21. As weight is applied to NLG 11, telescopic piston 19 will recede into strut cylinder 17, reducing the interior volume within NLG 11 and increasing internal pressure in proportion to the amount of additional weight applied. As weight is removed from NLG 11, telescopic piston 19 will extend from strut cylinder 17, increasing the interior volume within NLG 11 and reducing internal pressure in proportion to the amount of weight removed. Using the illustration of aircraft 4, as a Boeing 737-800; the weight and pressure values are provided in this illustration are used as an example only. Other aircraft types will have different weight and strut pressure values.

When NLG 11 reaches its full telescopic extension the internal pressure will reduce to 235 psi. This 235 psi pressure is referred to as the pre-charge pressure, which acts as an internal spring to assure the NLG reaches its full telescopic extension, when the aircraft takes-off, and the NLG 11 is retracted within the landing gear compartment, if the NLG 11 is not fully extended as the aircraft 4 takes-off, the misalignment of that NLG 11 entering the its landing gear compartment might cause damage to the aircraft structure.

It is assumed that the pre-charge pressure within the NLG 11 would be a constant value of 235 psi. It is not. U.S. Pat. No. 8,565,968—Nance, teaches of a method of monitoring in-flight landing gear strut pre-charge pressures. Aircraft landing gear are filled with hydraulic oil and compressed nitrogen gas. If a landing gear strut is discovered low, while sitting at the departure gate, bearing weight, often ground maintenance personnel will add gas into the landing gear strut, to return the strut telescopic extension to an acceptable appearance of Dimension Y. The question will remain as to why the strut Dimension Y appeared low. Did that landing gear strut loose oil or did it lose gas? U.S. Pat. No. 8,565,968 solves that problem. Use of the teachings of U.S. Pat. No. 8,565,968 can help in identifying when an improperly serviced NLG 11 has excess nitrogen gas, further resulting in a higher pre-charge pressure value. Thus when aircraft 4 is on the ground and in the loading process, as load is transferred away from NLG 11 the pre-charge pressure of 235 psi is typically used to identify the specific amount of internal gas spring for NLG 11. The NLG 11 internal strut pressure will not reduce to a correctly referenced value store within the computer 13 (shown in FIG. 1 and FIG. 7) look-up table, and a condition could exist where the low strut pressure setting set for triggering an alert could not be reached, and a false indication could result. An alternate means to confirm NLG 11 has reached its full telescopic extension is with the use, and monitoring of rotation sensor 77, attached to the scissor link 12 of NLG 11. This direct measurement of angle change in scissor-link 12 can identify when NLG 11 has reached full telescopic extension, even if the real-time monitored internal pressure indicated that NLG 11 has reached a correct pressure related to the Dimension X, being full telescopic extension. The apparatus and methods explained offer multiple cross-referencing abilities, to avoid false identification, or worse no indication; that unanticipated reduced loads on the NLG 11 are currently being experienced.

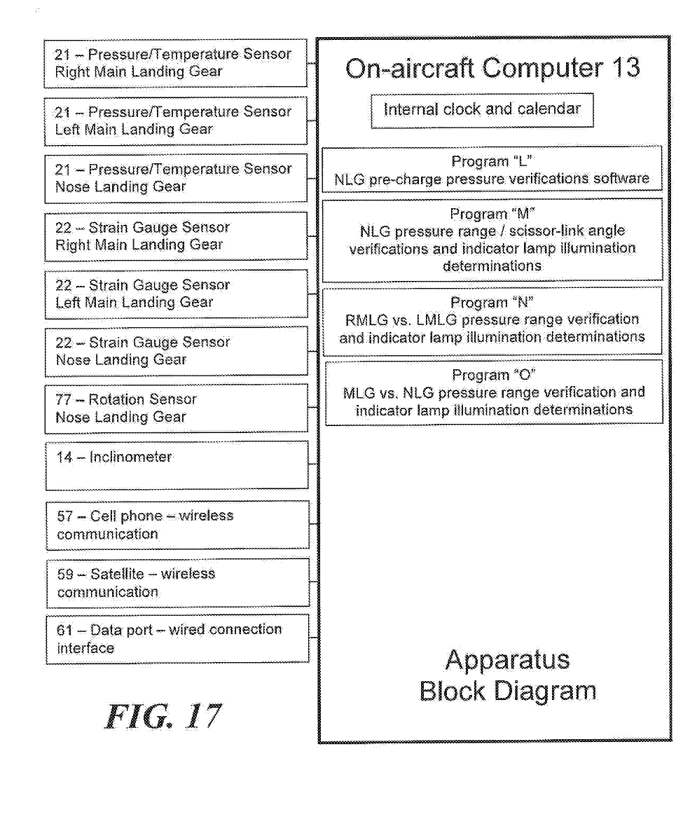

The illustration shown in FIG. 10a, has NLG 11 shown with a full-telescopically extended piston 19 “Dimension X”, where weight has moved away from NLG 11, either further AFT or out of the aircraft exit door, resulting in the NLG 11 internal strut pressure reducing to the “pre-charge” pressure of 235 psi. (235 psi as a pre-charge pressure is specified by the manufacturer for a properly service NLG strut.) If the NLG strut is improperly serviced, the pre-charge pressure will be slightly higher (described in more detail in FIG. 15). This results in unanticipated and extremely light loads being applied to NLG 11. The illustration shown in FIG. 10b has NLG 11 shown with a full-telescopically compressed piston 19 “Dimension Y”, where weight has moved towards NLG 11, either FWD or into the aircraft by way of exit door, resulting in the NLG 11 internal strut pressure increasing to a pressure of 1,826 psi. This results in unanticipated and extremely heavy loads being applied to NLG 11.

Referring now to FIG. 11 there is shown an example of a typical NLG load monitor and indicator 69. In the example shown, NLG load indicator 69 is positioned directly above and to the right side of the front aircraft door 57 (various airlines and aircraft manufacturers may choose different placement of indicator 69). Aircraft 4 has two FWD doors 57, each respective FWD door 57 are located at the same longitudinal location along the aircraft, where the port-side door 57 is used for passenger loading and the starboard-side door 57 is used simultaneously for the loading of the in-flight catering and beverage items. For this example door 57 can be referred to as the passenger door. The door has a porthole 58 or window and a handle 60 for latching, or securing, and unlatching the door to the fuselage.

Landing gear load indicator 69 has multiple lamps 71 and an audible alert speaker 75. Lamps 71 are of different colors, used to better identify the magnitude of the unanticipated loads being applied to NLG 11. Each respective lamp 71 color is identified by a corresponding 1^{st} letter: R represents a Red lamp, O represents an Orange lamp, Y represents a Yellow lamp, and G represents a Green lamp, and a corresponding number of 1-10 starting from the left and proceeding right.

The center lamps, namely the 4th-7th lamps are green and indicate that the loads on the MLGs 7, 9 and the NLG 11 are normal. Fewer or more green lamps can be used in the center of the indicator 69. No action beyond normal procedures are needed by the flight crew. The flight attendant greeting embarking passengers can, from time to time, glance up above the door to the indicator 69.

The lamps on either side of the green lights are color coded to show a change in the loads on the aircraft landing gear, from anticipated, or normal, loads, to unanticipated loads. In the preferred embodiment, the lights on either side of the green center change color from yellow to orange to red. Thus the 3rd and 8th lights are yellow, the 2nd and 9th lights are orange and the 1st and 10th lights are red. Various configurations can be used. For example, more or fewer lights can be used. Instead of 10 lights, three lights can be used (red-green-red). Using several green lights allows a higher resolution in indicating where the loads are and how the aircraft is balanced. Also, more or fewer colors can be used. For example, orange need not be used, only red-yellow-green-yellow-red. Using orange lights allows a higher resolution in indicating where the loads are and how the aircraft is balanced.

In FIG. 11, lamp 73 is shown as illuminated. Lamp 73 is Yellow, and identified as transitioning from the 4^{th} lamp to the 3rd lamp from the left, signifying that the loads are shifting toward the aft of the aircraft in an unanticipated and undesirable manner. Specifically, the loads on the NLG 11 are reducing to a level that may need some actions taken by the flight crew to better manage the flow of passenger traffic either departing the aircraft or moving AFT within the aircraft. The member of the flight crew in this example is a cabin flight attendant, who may take the action of stepping into the aircraft aisle to reduce the number of passengers, which can immediately depart and remove their weight from the aircraft. If the indicator's Orange lamp #2, located directly left of the #3 Yellow lamp 73 becomes illuminated, the flight attendant can announce to the passengers still on the aircraft that the jet-bridge is congested and request passengers to pause, while the jet-bridge congestion is relieved. This will allow more passengers to move FWD inside the aircraft, thus adding more weight FWD and transitioning to illumination of lamps #4, #5 or #6 to an illuminated Green lamp, identifying the loads on the NLG 11 have returned to an amount allowing safe exiting of the passengers from the aircraft.

In addition to the transition of illumination to the various colors of lamps 71, the indicator also offers an audible feature of having speaker 75. The speaker can sound a change in lights, for example when light #5 changes to light #4. Such an audible indication alerts the nearby flight attendant to look at the indicator 69 to assess the loading situation. If the lights change in color, for example, from green to yellow, the audible indication can be different to indicate the color change. For example, a more strident tone, or higher pitch, can be used. The flight attendant is thus alerted to look at the indication to assess the color change in lights and the loading situation.

Numerous variations of procedural actions may be taken by various airlines, in use of the NLG load-monitoring tool, including graduated thresholds for triggering the transition of lamps 71 and color changes, and/or the content or volume level of audible alerts that may be produced and transmitted by speaker 75, to help avoid tail-tipping and secure the safe operation of the aircraft 4.

As shown in FIG. 11, the indicator 69 has a line of lamps 71 or lights, which line allows a visual correlation to the load status. The central portion of the line, represented by the green lamps #4-7, indicates normal loads. Lamps outside of the central portion indicate loads outside of normal loads. Aircraft personnel can see the trending of the loads from normal to outside of normal as the lights change color and move along the line outside of the central portion. This allows aircraft personnel to take action in a preventative manner. For example, if light #6 is illuminated and then the indicator changes to light #7, a flight attendant can slow the loading of passengers onto the aircraft before yellow light #8 is illuminated.

As shown in FIG. 11, the length of the indicator 69, as provided by the line of lights, is aligned, or oriented, along the longitudinal axis 16 (shown in FIG. 13) of the aircraft fuselage. The longitudinal axis of the fuselage runs fore and aft. The lights along the indicator 69 are located along a line parallel to the longitudinal axis of the aircraft. By so orienting the indicator lights to the aircraft fuselage, the flight attendant is able to take quick action to alter loading or unloading. The flight attendant need not transpose the indicator information to another axis, which transposition could lead to error or delay in corrective action.

The indicator 69 is provided in non-cockpit areas of the aircraft. The cockpit area of the aircraft during operations is occupied by the pilots. As the aircraft is being readied for take-off, the pilots are engaged with checking the aircraft. The indicator can be provided in the cockpit area, visible to the pilots. However, providing the indicator to non-cockpit areas allows the crew other than the pilots to take action to rectify the loading situation. Examples of non-cockpit areas include the passenger compartment, such as by the front passenger loading door, one or both baggage compartments and one or both wing tank fueling ports. These non-cockpit areas are accessible toe aircraft personnel who, having been alerted to a potential loading and imbalance problem, can take action to rectify the situation.

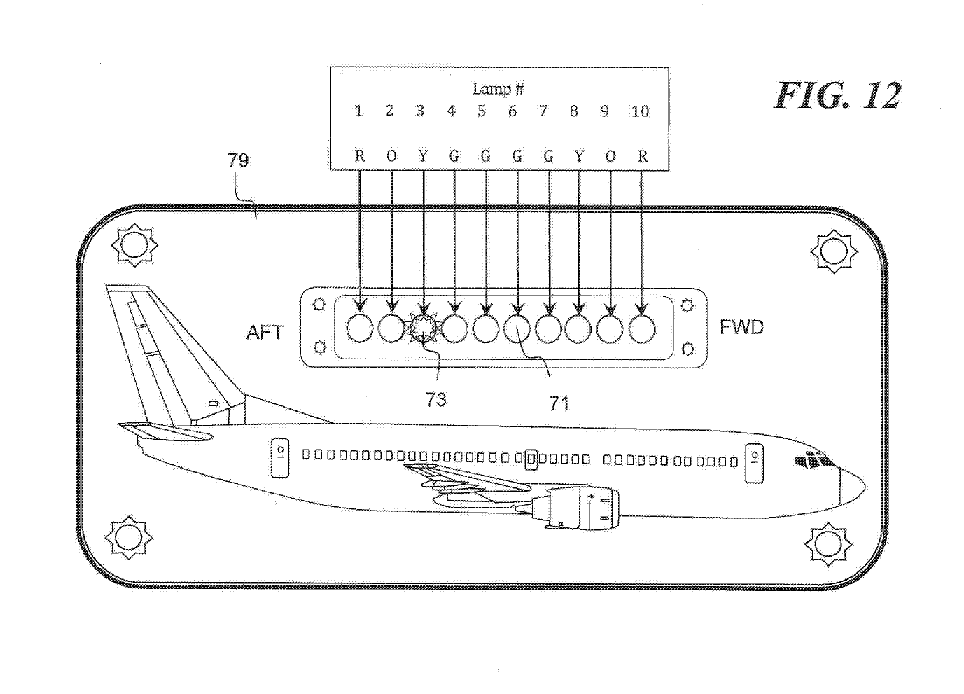

Referring now to FIG. 12 there is shown an example of an aircraft CG indicator 79. Aircraft CG indicator 79 can be installed onto the interior walls of FWD baggage compartment 61 and AFT baggage compartment 63 (see FIG. 7). In the example shown, CG indicator 79 is located at a position that is visible to the airline baggage loaders (various airlines may choose different placement of indicator 79).

Aircraft CG indicator 79 has multiple lamps 71. Lamps 71 are of different colors, used to better identify the magnitude of the unanticipated ranges of aircraft CG. A corresponding 1^{st} letter identifies each respective lamp 71 color: R represents a Red lamp, O represents an Orange lamp, Y represents a Yellow lamp, and G represents a Green lamp. In this illustration lamp 73 is shown as illuminated, and lamp 73 is Yellow, signifying hat the aircraft CG is nearing the AFT limit (aircraft FWD and AFT CG limits are shown in FIG. 5); and need actions taken by the baggage loaders to adjust the flow of baggage being loaded into both the AFT baggage compartment 63 and FWD baggage compartment 61, to insure aircraft CG limits are not exceeded.

In addition to the transition of illumination to the various colors of lamps 71, the indicator 79 can be equipped with an audible speaker 75, (not shown in this FIG. 12, but described and shown in FIG. 11). Numerous variations of procedural actions may be taken by various airlines, in use of the aircraft CG monitoring tool, including graduated thresholds for the triggering the transition of lamp 71 with color changes, and/or the content or volume level of audible alerts that may be produced and transmitted by speaker 75, to help avoid tail-tipping and secure the safe operation of the aircraft 4.

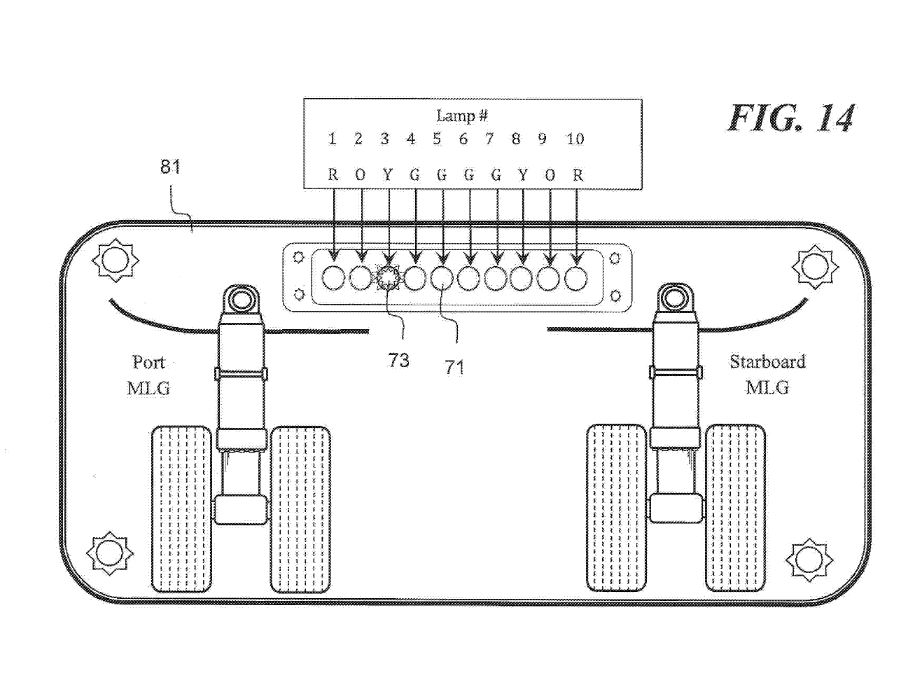

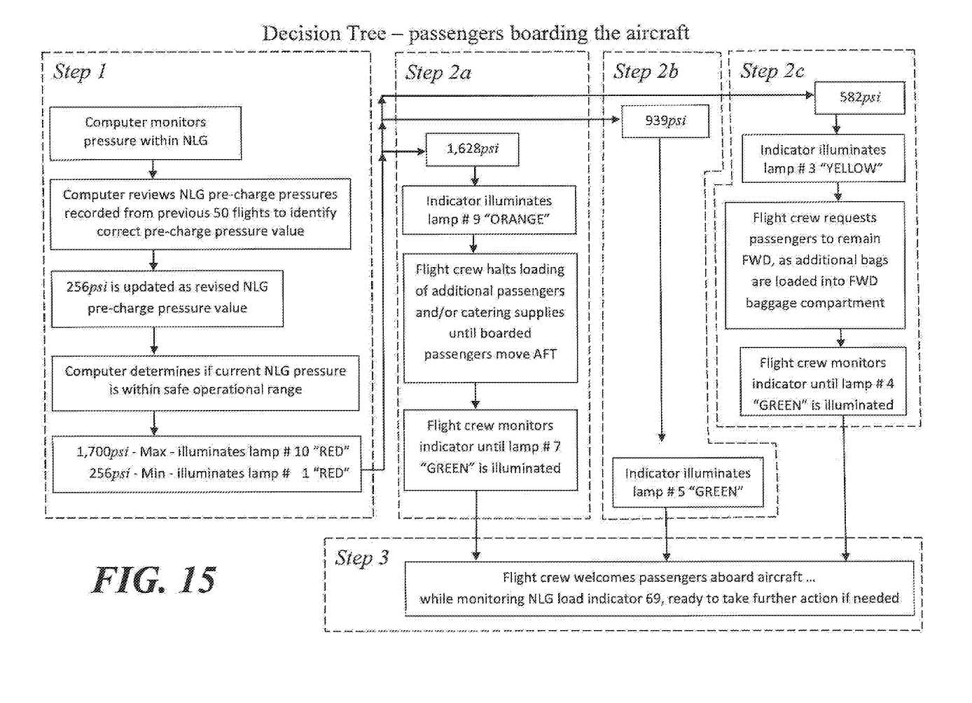

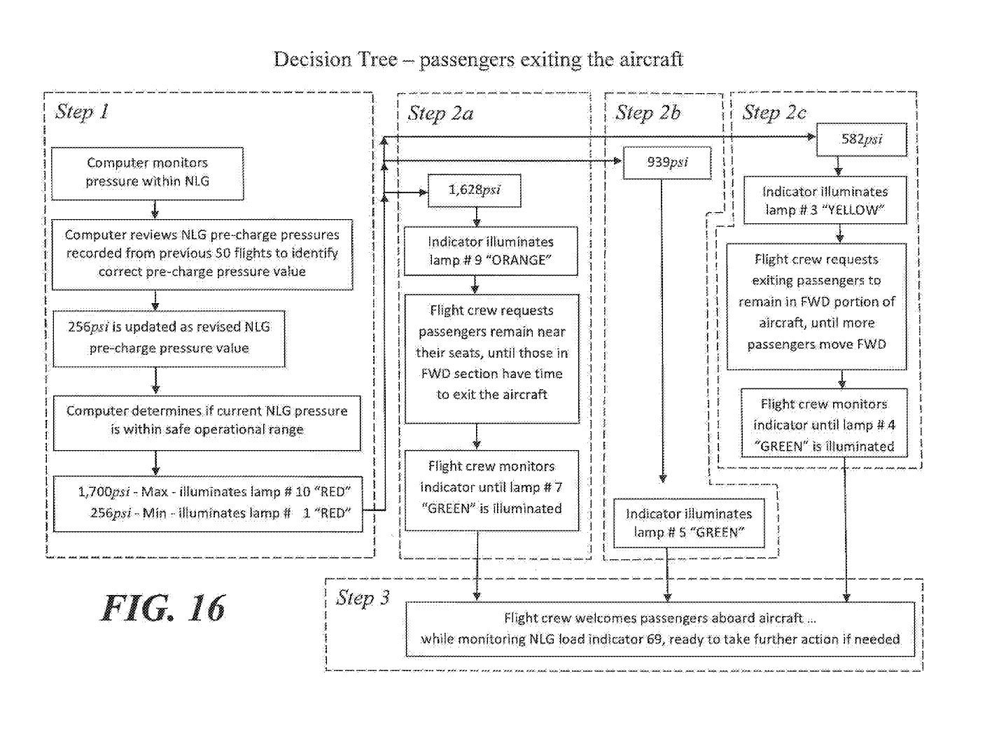

Referring now to FIG. 13 there is shown an overhead view of a typical set of aircraft wings, illustrating starboard wing 8 and port wing 10. Starboard wing 8 incorporates an internal wing fuel tank 83. Port wing 10 incorporates an internal wing tank 85. Right-starboard MLG 7 is mounted beneath and supports the loads generated by fuel currently held and fuel being added into starboard tank 83. Left-port MLG 9 is mounted beneath and supports the loads generated by fuel currently held and fuel being added into port tank 85. Dashed line 16 represent the longitudinal axis (center-line) of the aircraft. Black and white disk 15 illustrates the longitudinal CG of the aircraft, as it transitions along the longitudinal axis line 16. Black and white disk 87 illustrates the lateral CG of the aircraft. In the example shown, the lateral CG 8 is not aligned with the center-line 16 of the aircraft. The port MLG 9 is supporting more weight than is the starboard MLG 7. Wing-fuel imbalance inductor 81 (shown in FIG. 14) illustrates how the fuel loading imbalance indicator 81 can be monitored by the aircraft fuel loaders, to better manage movement of lateral CG 87, in attempts to maintain a closer proximity to center-line axis 16.

Referring now to FIG. 14 there is shown an example of a wing-tank fuel imbalance indicator (“fuel imbalance indictor”) 81. Fuel imbalance indicators 81 are installed adjacent to wing-tank fuel loading nozzles (not shown), and used by aircraft fuel loaders pumping fuel into wing-tank 83 and wing-tank 85; to avoid possible asymmetrical fuel load imbalances which are not maintained along the longitudinal centerline 16 of the aircraft (see FIG. 13). Though independent digital fuel quantity gauges are typically mounted at the fuel loading nozzles on each respective wing; no real-time comparison with an “illustrated reference” identifying unanticipated loads being applied to opposing RMLG 7 and LMLG 9 are available. Use of fuel imbalance indicator 81 creates a further layer of accuracy for safe aircraft operations.

Fuel imbalance indicator 81 has multiple lamps 71. Lamps 71 are of different colors, used to better identify the magnitude of the unanticipated ranges of aircraft lateral CG caused by an imbalance of fuel load within the opposing aircraft wings. A corresponding 1^{st} letter identifies each respective lamp 71 color. R represents a Red lamp, O represents an Orange lamp, Y represents a Yellow lamp, and G represents a Green lamp. In this illustration lamp 73 is shown as illuminated, and lamp 73 is Yellow, signifying the aircraft lateral CG is nearing the port-side limit (see FIG. 13). This indication suggests actions need be taken by the fuel loaders to insure fuel pumped into the starboard (opposing) wing is sufficient to correct for the fuel quantity asymmetry and imbalanced fuel load, to insure aircraft lateral CG limits are not exceeded.

In addition to the transition of illumination to the various colors of lamps 71, the indicator 81 can be equipped with an audible speaker 75, (not shown in this FIG. 14, but described and shown in FIG. 11).

Note that the indicator of FIG. 14 need not be aligned perpendicularly to the longitudinal axis of the aircraft. The indicator includes a frame of reference, namely images of the two MLGs, with the lights 71 oriented with respect to those images. Thus, a fuel loader can see the lights on the right side corresponding with increasing weight on the RMLG and gather lights on the left side corresponding to increased weight on the LMLG.

Referring now to FIG. 15 there is shown a decision tree for use by airline personnel as they consider and use the NLG load indicator 69 (shown in FIG. 11) during the passenger boarding process onto the aircraft 4 (shown in FIG. 7 and FIG. 8). The decision tree is divided into three transitional of steps: Step 1, Steps 2a, 2b, 2c and Step 3.

Step 1 starts with the computer 13 monitoring the pressure within the NLG 11 (shown in FIG. 7, FIG. 8 and FIGS. 10a-10b). The computer can be triggered to measure strut pressures in a variety of ways such as by the pilots, by the aircraft located at a jet-bridge (using GPS or Global Positioning System to determine location), etc. The computer 13 then reviews a to-be-defined number of previous flights (in this example 50 flight) to determine the NLG “pre-charge” pressure associated with a fully extended NLG strut. Using the Boeing 737-800 aircraft as an example, the proper NLG pre-charge pressure should be 235 psi. If the landing gear happens to lose hydraulic oil and is mistakenly re-serviced with additional nitrogen gas, the NLG strut pre-charge pressure will be higher, in direct proportion to the amount of hydraulic oil that was lost and replaced by gas. In this example shown, the NLG pre-charge pressure has been identified at 278 psi. Using an incorrect value for NLG pre-charge pressure can result in NLG pressure not reducing to a triggering event, and would further indicate erroneous loads currently experienced by the NLG strut. Step 1 continues with update of the minimum pressure anticipated from the NLG to be 235 psi, and makes no adjustment to the 1,790 psi in pressure associated with the triggering of the #10 RED lamp on indicator 69. If the pressure is the NLG is less than or equal to 380 psi, the lamp #1 is illuminated. If the pressure is the NLG is greater than or equal to 1,790 psi, the lamp #10 is illuminated.

Step 2 has three alternatives. FIG. 15 does not show the conditions for all of the lamps to be illuminated, but only examples.

Step 2a has the computer 13 finding a NLG strut pressure of between 380 psi and 504 psi triggering the illumination of the lamp #9—ORANGE lamp of indicator 69. The flight crew recognition of this event will have the flight crew taking steps to halt additional load being applied to NLG 11, until passengers have time to move further AFT in the aircraft cabin. Once passengers have moved further AFT, and NLG 11 loads are reduced to a point where indicator lamp #7—GREEN is illuminated, the flight attendant can then allow passengers to proceed in their normal boarding procedures.

Although not shown by FIG. 15, step 2b has computer finding a NLG strut pressure of between 505 psi and 611 psi, triggering the illumination of lamp #8, YELLOW. When the NLG pressure is between 612 psi and 732 psi, then the computer triggers the illumination of the lamp #7, the GREEN lamp of indicator 69. When the NLG pressure is between 733 psi and 854 psi, then the computer triggers the illumination of the lamp #6—the GREEN lamp of indicator 69. When the NLG pressure is between 855 psi and 1,041 psi, then the computer triggers the illumination of the lamp #5—the GREEN lamp of indicator 69 (see FIG. 15). When one of the GREEN lights illuminates, the flight crew recognizes that NLG 11 is experiencing no unanticipated loads, and the flight attendant can allow passengers to proceed in their normal boarding procedures.

Although not shown by FIG. 15, step 2c has computer 213 finding a NLG strut pressure of between 1,042 psi and 1,226 psi, triggering the illumination of lamp #4, GREEN. Step 2c has computer finding a NLG strut pressure of between 1,227 psi and 1,388 psi triggering the illumination of the lamp #3—the YELLOW lamp of indicator 69. The flight crew recognition of this event will have the flight crew taking steps to halt any loads being removed from NLG 11, by requesting passengers to move no further AFT until additional passengers or catering items can be loaded into the FWD area of the cabin, through the front door. Once additional passengers have boarded the aircraft, and NLG 11 loads are increased to a point where indicator lamp #4—GREEN is illuminated, the flight attendant can then allow passengers to proceed in their normal boarding procedures.

If the computer 13 finds an NLG strut pressure of between 1,389 psi and 1,551 psi, it triggers the illumination of the lamp #2—ORANGE lamp of indicator 69. The yellow and orange lights indicate to the crew that action needs to be taken immediately to correct the loading. If the computer 13 finds an NLG strut pressure of between 1,552 psi and 1,790 psi, it triggers the illumination of the lamp #10—RED lamp of indicator 69, meaning that the NLG is overloaded and that the crew should immediately correct the loading.

Referring now to FIG. 16 there is shown a decision tree for use by airline personnel as they consider and use of the NLG load indicator 69 (shown in FIG. 11) as passenger exit the aircraft 4 (shown in FIG. 7 and FIG. 8). The decision tree is divided into three transitional steps: Step 1, Steps 2a, 2b, 2c and Step 3. The same pressure ranges for FIG. 15 for the individual lights are applicable to the process of FIG. 16. Note that the pressure ranges are by way of example and can be varied. Also, the number of pressure ranges can be varied. Ten pressure ranges are shown in the example, with each range corresponding to a light on the indicator 69, but fewer or more lights can be used.

Step 1 starts with NLG load indicator 69 monitoring the pressure within the NLG 11 (shown in FIG. 7, FIG. 8 and FIGS. 10a-10b). NLG load indicator 69 then reviews a to be defined number of previous flights (as described in FIG. 15) to determine the NLG “pre-charge” pressure associated with a fully extended NLG strut.

Step 2 has three alternatives.

Step 2a has indicator 69 finding a NLG strut pressure of 1,692 psi triggering the illumination of the lamp #9—ORANGE lamp of indicator 69. The flight crew recognition of this event will have the flight crew taking steps to halt additional load being applied to NLG 11, by temporarily restricting passengers from moving further FWD in the aircraft cabin. Once passengers in the FWD section of the aircraft have exited the aircraft, and NLG 11 loads are reduced to a point where indicator lamp #7—GREEN is illuminated, the flight attendant can then allow passengers to proceed in their normal boarding procedures.

Step 2b has indicator 69 finding a NLG strut pressure of 939 psi triggering the illumination of the lamp #5—the GREEN lamp of indicator 69. The flight crew recognition that NLG 11 is experiencing no unanticipated loads, the flight attendant can allow passengers to proceed in their normal exiting procedures.

Step 2c has indicator 69 finding a NLG strut pressure of 582 psi triggering the illumination of the lamp #3—the YELLOW lamp of indicator 69. The flight crew recognition of this event will have the flight crew taking steps to halt any loads being removed from NLG 11, by requesting passengers to temporarily not exit the aircraft through the front door, allowing additional time for any passengers still remaining in the AFT section of the aircraft to move FWD, bring more weight onto the NLG. Once additional passengers have move FWD in the aircraft, and NLG 11 loads are increased to a point where indicator lamp #4—GREEN is illuminated, the flight attendant can then allow passengers to proceed in their normal exiting procedures.

In this Example: the use of 380 psi as the pressure threshold to illuminate lamp #1, as opposed to a using the typical NLG pre-charge pressure of 235 psi, being the minimum pressure available for measurement and is equal to the measurable pressure associated with full telescopic extension of the NLG strut. Use of 380 psi is to maintain a greater safety margin above what would be associated with the minimum 235 psi contained within a properly serviced NLG at full telescopic extension; or even a pressure threshold of 278 psi, which might be identified by this system as the pre-charge pressure of a fully extended NLG, which has been improperly serviced with excess nitrogen gas. The objective of using a pressure threshold higher than the typical pressure associated with a fully extended NLG strut which has been improperly serviced with excess nitrogen gas, is to avoid a false indication, where the strut pressure of a fully extended NLG cannot reduce to a pre-set trigger of pressure threshold (i.e.: 235 psi) to illuminated Lamp #1.

Regarding lateral CG due to asymmetrical fuel loading; the pressure ranges that trigger illumination of various indicator lamps 1 through 10 are determined based upon a differential pressure between the respective pressures on the RMLG and LMLG. The Boeing 737-800 fuel loading requires opposing fuel tanks have no more than 1,000 lb. difference in the tanks. The wing fuel tanks extend to a length of 42 feet outboard of each respective MLG strut. The additional 1,000 lb. of weight leveraged at an assumed 21 feet centered outboard of the MLG generates a higher strut pressure, than the pressure needed to merely show a 1,000 lb. weight increase, centered over the top of each respective MLG strut.

As an Example: the aircraft total weight of 141,837 lb.

| LMLG psi | RMLG psi | Differential psi | Light # | Light color |
|---|---|---|---|---|
| 1,525 | 1,775 | 250 | 1 | RED |
| 1,550 | 1750 | 200 | 2 | ORANGE |
| 1,575 | 1,725 | 150 | 3 | YELLOW |
| 1,600 | 1,700 | 100 | 4 | GREEN |
| 1,625 | 1,675 | 50 | 5 | GREEN |
| 1,675 | 1,625 | 50 | 6 | GREEN |
| 1,700 | 1,600 | 100 | 7 | GREEN |
| 1,725 | 1,575 | 150 | 8 | YELLOW |
| 1,750 | 1,550 | 200 | 9 | ORANGE |
| 1,775 | 1,525 | 250 | 10 | RED |

A fuel handler can view the indicator 81 while fuel is being loaded onto the aircraft. If light #s 4-7 are illuminated, the fuel handler knows that the fuel load is properly balanced between the two MLGs. However, if, a non-Green light is illuminated, the fuel handler can take steps to rebalance the load. For example, suppose light #3 illuminates, the fuel handler sees that the fuel load on the RMLG is too heavy relative to the load on the LMLG. The fuel handler can take steps to rebalance the load, such as diverting fuel into the left wing tank and not the right wing tank.

The indicators 69, 79, 81 of FIGS. 11, 12 and 14 all share the characteristic of having a linear arrangement of lights, with a central area of normal loads. The outer areas of lights indicate abnormal loads. In addition to this spatial correspondence, the lights have different colors to indicate normal (green) and abnormal (yellow, orange, red).

Referring now to FIG. 17, there is shown an additional block diagram illustrating the apparatus and software of the invention, with multiple (nose, left-main and right-main landing gear) pressure sensors 21 which supply landing gear strut pressure data inputs into computer 13 (shown in FIG. 7). Additionally, a rotation sensor 77 on the NLG (shown in FIG. 10a) supplies voltage data inputs corresponding to NLG scissor-link angle and change of angle into computer 13. Computer 13 is equipped with an internal clock and calendar to document the time and date of stored data.

Computer 13 has multiple software packages, which include:
Program “L”—a software routine for monitoring NLG pressure during aircraft flight, to verify and validate current NLG pre-charge pressure.
Program “M”—a software routine for monitoring NLG strut pressure during aircraft loading and un-loading, and compare to NLG scissor link angle, to further determine appropriate indicator lamp illumination.
Program “N”—a software routine for comparison of asymmetrical RMLG strut pressure compared to LMLG strut pressure, to identify wing fuel tank imbalance, to further determine appropriate fuel imbalance indicator lamp illumination.
Program “O”—a software routine for further use Program D (see FIG. 6) to determine appropriate baggage compartment indicator lamp illumination.

Additionally, as an exemplary embodiment of the invention has been disclosed and discussed, it will be understood that other applications of the invention are possible and that the embodiment disclosed may be subject to various changes, modifications, and substitutions without necessarily departing from the spirit and scope of the invention.

1. A method of determining and identifying acceptable and unacceptable ranges of loads applied to a nose landing gear of an aircraft on the ground during a loading event, the aircraft comprising a cockpit and non-cockpit areas, the non-cockpit areas accessible to aircraft personnel, comprising the steps of:
a) Measuring the load supported by the nose landing gear during the loading event;
b) Determining if the measured load on the nose landing gear is within a first predetermined range of acceptable loads;
c) If the measured load on the nose landing gear is within the first predetermined range of acceptable loads, providing an indication that the loads are acceptable to at least one of the non-cockpit areas of the aircraft;
d) Determining if the measured load on the nose landing gear changes to a load that is outside of the first predetermined range of acceptable loads;
e) If the measured load on the nose landing gear is outside the first predetermined range of acceptable loads, providing an indication that the loads are unacceptable to the at least one non-cockpit areas of the aircraft.

2. The method of determining and identifying acceptable and unacceptable ranges of loads applied to the nose landing gear of an aircraft on the ground during a loading event of claim 1 wherein the loading event comprises loading passengers and baggage onto the aircraft.

3. The method of determining and identifying acceptable and unacceptable ranges of loads applied to the nose landing gear of an aircraft on the ground during a loading event of claim 1 wherein the loading event comprises unloading passengers and baggage from the aircraft.

4. The method determining and identifying acceptable and unacceptable ranges of loads applied to the nose landing gear of an aircraft on the ground during a loading event of claim 1 further comprising the steps of:
a) After the measured load on the nose landing gear is outside of the first predetermined range of acceptable loads, determining if the measured load on the nose landing gear changes to within the first predetermined range of acceptable loads;
b) If the measured load on the nose landing gear changes to within the first predetermined range of acceptable loads, providing an indication that the loads are acceptable to at least one of the non-cockpit areas of the aircraft.

5. The method determining and identifying acceptable and unacceptable ranges of loads applied to the nose landing gear of an aircraft on the ground during a loading event of claim 1 wherein the step of determining if the measured load on the nose landing gear is within a first predetermined range of acceptable loads, further comprising the steps of:
a) Storing the measured loads on the nose landing gear strut from previous loading events;
b) From the stored measured loads, identifying the pre-charge pressure of the nose landing gear strut;
c) Determining if the measured load on the nose landing gear is within a first predetermined range of acceptable loads, using the identified pre-charge pressure on the nose landing gear strut.

6. The method determining and identifying acceptable and unacceptable ranges of loads applied to the nose landing gear of an aircraft on the ground during a loading event of claim 1, wherein the steps of providing an indication of the loads to at least one of the non-cockpit areas of the aircraft, further comprises the step of providing a visual indication of lights arranged in a linear manner, with the loads that are acceptable indicated by a light in a central area of the lights and with the loads that are unacceptable indicated by a light that is outside of the central area of the lights.

7. The method determining and identifying acceptable and unacceptable ranges of loads applied to the nose landing gear of an aircraft on the ground during a loading event of claim 6, wherein the steps of providing an indication of the loads to at least one of the non-cockpit areas of the aircraft, further comprises the step of providing a visual indication by a front passenger loading door of the aircraft.

8. The method determining and identifying acceptable and unacceptable ranges of loads applied to the nose landing gear of an aircraft on the ground during a loading event of claim 6, wherein the steps of providing an indication of the loads to at least one of the non-cockpit areas of the aircraft, further comprises the step of providing a visual indication in a baggage compartment of the aircraft.

9. A method of determining and identifying acceptable and unacceptable ranges of loads applied to main landing gear of an aircraft on the ground during a loading event, the aircraft comprising a cockpit and non-cockpit areas, the non-cockpit areas accessible to aircraft personnel, comprising the steps of:
a) Measuring the loads supported by each of the main landing gear during the loading event;
b) Determining if the measured loads on the main landing gear are within a first predetermined range of acceptable loads,
c) If the measured loads on the main landing gear are within the first predetermined range of acceptable loads, providing an indication that the loads are acceptable to at least one of the non-cockpit areas of the aircraft;
d) Determining if the measured loads on the main landing gear changes to a load that is outside of the first predetermined range of acceptable loads;
e) If the measured loads on the main landing gear are outside the first predetermined range of acceptable loads, providing an indication that the loads are unacceptable to the at least one non-cockpit areas of the aircraft.

10. The method of determining and identifying acceptable and unacceptable ranges of loads applied to the main landing gear of an aircraft on the ground during a loading event of claim 9 wherein the loading event comprises loading fuel onto the aircraft.

11. The method determining and identifying acceptable and unacceptable ranges of loads applied to the main landing gear of an aircraft on the ground during a loading event of claim 9, further comprising the steps of:
a) After the measured loads on the main landing gear are outside of the first predetermined range of acceptable loads, determining if the measured loads on the main landing gear change to within the first predetermined range of acceptable loads;
b) If the measured loads on the main landing gear change to within the first predetermined range of acceptable loads, providing an indication that the loads are acceptable to at least one of the non-cockpit areas of the aircraft.

12. The method determining and identifying acceptable and unacceptable ranges of loads applied to the main landing gear of an aircraft on the ground during a loading event of claim 9, wherein the steps of providing an indication of the loads to at least one of the non-cockpit areas of the aircraft, further comprises the step of providing a visual indication of lights arranged in a linear manner, with the loads that are acceptable indicated by a light in a central area of the lights and with the loads that are unacceptable indicated by a light that is outside of the central area of the lights.

13. The method determining and identifying acceptable and unacceptable ranges of loads applied to the main landing gear of an aircraft on the ground during a loading event of claim 12, wherein the steps of providing an indication of the loads to at least one of the non-cockpit areas of the aircraft, further comprises the step of providing a visual indication by a fueling port of the aircraft.
